(19) United States
(12) Patent Application Publication
(10) Pub. No.: US 2007/0136412 A1
(43) Pub. Date: Jun. 14, 2007

(54) INTEGRATION OF XML AND TLV FOR QUERY AND/OR RESPONSES IN NETWORK DISCOVERY FOR MOBILE DEVICES

(76) Inventors: Yoshihiro Oba, Englewood Cliffs, NJ (US); Kenichi Taniuchi, Jersey City, NJ (US); Subir Das, Kendall Park, NJ (US)

Correspondence Address: WATCHSTONE P + D, 1250 CONNECTICUT AVENUE, N.W., SUITE 700, WASHINGTON, DC, 20036, US

(21) Appl. No.: 11/460,616

(22) Filed: Jul. 27, 2006

Related U.S. Application Data
(60) Provisional application No. 60/596,841, filed on Oct. 25, 2005.

(51) Int. Cl. G06F 15/16

(52) U.S. Cl. 709/200

(57) ABSTRACT

In some of the preferred embodiments, methods for converting XML data to TLV format are provided for use in, e.g., query and/or response in, e.g., network discovery and the like applications.

### CROSS REFERENCED APPLICATIONS

The present application claims priority under 35 U.S.C. 119 to the following Provisional Patent Application Ser. No. 60/596,841, filed Oct. 25, 2005, to Y. Ohba, et al., entitled Integration of XML and TLV, the entire disclosure of which is incorporated herein by reference.

The present application improves upon each of the following U.S. Provisional Patent Applications: 1) Ser. No. 60/625,106, filed on Nov. 5, 2004, entitled Network Discovery Mechanism For Secure Fast Handoff; 2) Ser. No. 60/593,377, filed on Jan. 9, 2005, entitled Network Discovery Mechanisms; 3) Ser. No. 60/670,655, filed on Apr. 13, 2005, entitled Network Discovery Mechanisms; and 4) Ser. No. 60/697,589, filed on Jul. 11, 2005, entitled RDF Schema Update for 802.1 Baseline Document—the entire disclosures of each of the foregoing four provisional patent applications to which priority is claimed are incorporated herein in their entireties. In addition, the entire disclosures of each of the following co-pending patent applications of the present assignee are incorporated herein by reference for background: U.S. patent application Ser. No. 10/761,243 entitled Mobility Architecture Using Pre-Authentication, Pre-Configuration and/or Virtual Soft-Handoff, filed on Jan. 22, 2004.

### BACKGROUND

1. Field of the Invention

The present application relates to, inter alia, the integration of XML and TLV for network discovery and/or media independent handover for wireless networks.

2. Background Discussion

Networks and Internet Protocol:

There are many types of computer networks, with the Internet having the most notoriety. The Internet is a worldwide network of computer networks. Today, the Internet is a public and self-sustaining network that is available to many millions of users. The Internet uses a set of communication protocols called TCP/IP (i.e., Transmission Control Protocol/lInternet Protocol) to connect hosts. The Internet has a communications infrastructure known as the Internet backbone. Access to the Internet backbone is largely controlled by Internet Service Providers (ISPs) that resell access to corporations and individuals.

With respect to IP (Internet Protocol), this is a protocol by which data can be sent from one device (e.g., a phone, a PDA [Personal Digital Assistant], a computer, etc.) to another device on a network. There are a variety of versions of IP today, including, e.g., IPv4, IPv6, etc. Each host device on the network has at least one IP address that is its own unique identifier. IP is a connectionless protocol. The connection between end points during a communication is not continuous. When a user sends or receives data or messages, the data or messages are divided into components known as packets. Every packet is treated as an independent unit of data.

In order to standardize the transmission between points over the Internet or the like networks, an OSI (Open Systems Interconnection) model was established. The OSI model separates the communications processes between two points in a network into seven stacked layers, with each layer adding its own set of functions. Each device handles a message so that there is a downward flow through each layer at a sending end point and an upward flow through the layers at a receiving end point. The programming and/or hardware that provides the seven layers of function is typically a combination of device operating systems, application software, TCP/IP and/or other transport and network protocols, and other software and hardware.

Typically, the top four layers are used when a message passes from or to a user and the bottom three layers are used when a message passes through a device (e.g., an IP host device). An IP host is any device on the network that is capable of transmitting and receiving IP packets, such as a server, a router or a workstation. Messages destined for some other host are not passed up to the upper layers but are forwarded to the other host. The layers of the OSI model are listed below. Layer 7 (i.e., the application layer) is a layer at which, e.g., communication partners are identified, quality of service is identified, user authentication and privacy are considered, constraints on data syntax are identified, etc. Layer 6 (i.e., the presentation layer) is a layer that, e.g., converts incoming and outgoing data from one presentation format to another, etc. Layer 5 (i.e., the session layer) is a layer that, e.g., sets up, coordinates, and terminates conversations, exchanges and dialogs between the applications, etc. Layer-4 (i.e., the transport layer) is a layer that, e.g., manages end-to-end control and error-checking, etc. Layer-3 (i.e., the network layer) is a layer that, e.g., handles routing and forwarding, etc. Layer-2 (i.e., the data-link layer) is a layer that, e.g., provides synchronization for the physical level, does bit-stuffing and furnishes transmission protocol knowledge and management, etc. The Institute of Electrical and Electronics Engineers (IEEE) sub-divides the data-link layer into two further sub-layers, the MAC (Media Access Control) layer that controls the data transfer to and from the physical layer and the LLC (Logical Link Control) layer that interfaces with the network layer and interprets commands and performs error recovery. Layer 1 (i.e., the physical layer) is a layer that, e.g., conveys the bit stream through the network at the physical level. The IEEE sub-divides the physical layer into the PLCP (Physical Layer Convergence Procedure) sub-layer and the PMD (Physical Medium Dependent) sub-layer.

Wireless Networks:

Wireless networks can incorporate a variety of types of mobile devices, such as, e.g., cellular and wireless telephones, PCs (personal computers), laptop computers, wearable computers, cordless phones, pagers, headsets, printers, PDAs, etc. For example, mobile devices may include digital systems to secure fast wireless transmissions of voice and/or data. Typical mobile devices include some or all of the following components: a transceiver (i.e., a transmitter and a receiver, including, e.g., a single chip transceiver with an integrated transmitter, receiver and, if desired, other functions); an antenna; a processor; one or more audio transducers (for example, a speaker or a microphone as in devices for audio communications); electromagnetic data storage (such as, e.g., ROM, RAM, digital data storage, etc., such as in devices where data processing is provided); memory; flash memory; a full chip set or integrated circuit; interfaces (such as, e.g., USB, CODEC, UART, PCM, etc.); and/or the like.

Wireless LANs (WLANs) in which a mobile user can connect to a local area network (LAN) through a wireless connection may be employed for wireless communications. Wireless communications can include, e.g., communications that propagate via electromagnetic waves, such as light, infrared, radio, microwave. There are a variety of WLAN standards that currently exist, such as, e.g., Bluetooth, IEEE 802.11, and HomeRF.

By way of example, Bluetooth products may be used to provide links between mobile computers, mobile phones, portable handheld devices, personal digital assistants (PDAs), and other mobile devices and connectivity to the Internet. Bluetooth is a computing and telecommunications industry specification that details how mobile devices can easily interconnect with each other and with non-mobile devices using a short-range wireless connection. Bluetooth creates a digital wireless protocol to address end-user problems arising from the proliferation of various mobile devices that need to keep data synchronized and consistent from one device to another, thereby allowing equipment from different vendors to work seamlessly together. Bluetooth devices may be named according to a common naming concept. For example, a Bluetooth device may possess a Bluetooth Device Name (BDN) or a name associated with a unique Bluetooth Device Address (BDA). Bluetooth devices may also participate in an Internet Protocol (IP) network. If a Bluetooth device functions on an IP network, it may be provided with an IP address and an IP (network) name. Thus, a Bluetooth Device configured to participate on an IP network may contain, e.g., a BDN, a BDA, an IP address and an IP name. The term “IP name” refers to a name corresponding to an IP address of an interface.

An IEEE standard, IEEE 802.11, specifies technologies for wireless LANs and devices. Using 802.11, wireless networking may be accomplished with each single base station supporting several devices. In some examples, devices may come pre-equipped with wireless hardware or a user may install a separate piece of hardware, such as a card, that may include an antenna. By way of example, devices used in 802.11 typically include three notable elements, whether or not the device is an access point (AP), a mobile station (STA), a bridge, a PCMCIA card or another device: a radio transceiver; an antenna; and a MAC (Media Access Control) layer that controls packet flow between points in a network.

In addition, Multiple Interface Devices (MIDs) may be utilized in some wireless networks. MIDs may contain two independent network interfaces, such as a Bluetooth interface and an 802.11 interface, thus allowing the MID to participate on two separate networks as well as to interface with Bluetooth devices. The MID may have an IP address and a common IP (network) name associated with the IP address.

Wireless network devices may include, but are not limited to Bluetooth devices, Multiple Interface Devices (MIDs), 802.11x devices (IEEE 802.11 devices including, e.g., 802.11a, 802.11b and 802.11g devices), HomeRF (Home Radio Frequency) devices, Wi-Fi (Wireless Fidelity) devices, GPRS (General Packet Radio Service) devices, 3G cellular devices, 2.5G cellular devices, GSM (Global System for Mobile Communications) devices, EDGE (Enhanced Data for GSM Evolution) devices, TDMA type (Time Division Multiple Access) devices, or CDMA type (Code Division Multiple Access) devices, including CDMA2000. Each network device may contain addresses of varying types including but not limited to an IP address, a Bluetooth Device Address, a Bluetooth Common Name, a Bluetooth IP address, a Bluetooth IP Common Name, an 802.11 IP Address, an 802.11 IP common Name, or an IEEE MAC address.

Wireless networks can also involve methods and protocols found in, e.g., Mobile IP (Internet Protocol) systems, in PCS systems, and in other mobile network systems. With respect to Mobile IP, this involves a standard communications protocol created by the Internet Engineering Task Force (IETF). With Mobile IP, mobile device users can move across networks while maintaining their IP Address assigned once. See Request for Comments (RFC) 3344. NB: RFCs are formal documents of the Internet Engineering Task Force (IETF). Mobile IP enhances Internet Protocol (IP) and adds means to forward Internet traffic to mobile devices when connecting outside their home network. Mobile IP assigns each mobile node a home address on its home network and a care-of-address (CoA) that identifies the current location of the device within a network and its subnets. When a device is moved to a different network, it receives a new care-of address. A mobility agent on the home network can associate each home address with its care-of address. The mobile node can send the home agent a binding update each time it changes its care-of address using, e.g., Internet Control Message Protocol (ICMP).

In basic IP routing (e.g., outside mobile IP), routing mechanisms rely on the assumptions that each network node always has a constant attachment point to, e.g., the Internet and that each node's IP address identifies the network link it is attached to. In this document, the terminology “node” includes a connection point, which can include, e.g., a redistribution point or an end point for data transmissions, and which can recognize, process and/or forward communications to other nodes. For example, Internet routers can look at, e.g., an IP address prefix or the like identifying a device's network. Then, at a network level, routers can look at, e.g., a set of bits identifying a particular subnet. Then, at a subnet level, routers can look at, e.g., a set of bits identifying a particular device. With typical mobile IP communications, if a user disconnects a mobile device from, e.g., the Internet and tries to reconnect it at a new subnet, then the device has to be reconfigured with a new IP address, a proper netmask and a default router. Otherwise, routing protocols would not be able to deliver the packets properly.

The preferred embodiments improve upon technologies described, e.g., in the following references, each of which is incorporated herein by reference in its entirety:
[1] Sun Microsystems,. Jini Connection Technology,. http://www.sun.com/jinni.
[2] Sun Microsystems,. Jini Community Resources: Jini Technology Architectural Overview,. January 1999. http://www.sun.com/jini/whitepapers/architecture. html.
[3] Sun Microsystems,. Jini Community Resources: Jini Specification v1.0.1,. www.sun.com/jini/specs.
[4] W. Keith Edwards, Core JINI, The Sun Microsystems Press Java Series, Prentice Hall, 1999.
[5] Microsoft Corporation, Universal Plug and Play: Background, http://www.upnp.org/resources/UpnPbkgnd.htm.
[6] Microsoft Corporation,. Universal Plug and Play Device Architecture Version 1.0,. Jun. 8, 2000. http: A//wwwupnp.org/UpnPDevice Architectur 1.0 htm.
[7] Yaron Y. Goland, Ting Cai, Paul Leach, Ye Gu, and Shivaun Albright, Simple Service Discovery Protocol,. IETF Draft draft-cai-ssdp-v1-03.txt, Oct. 28, 1999. http://www.ietf.org/internetdrafts/draft-cai-ssdp-v1-03.txt.
[8] Salutation,. Consortium, Salutation Architecture Specification Version 2.0c . Part 1,. The Salutation Consortium, Jun. 1, 1999. http://www.salutation.org.
[9] Salutation Consortium,. Salutation Architecture Specification Version 2.0c . Part 2,. The Salutation Consorium, Jun. 1, 1999. http://www.salutation.org.
[10] Bob Pascoe,. Salutation-Lite: Find-and-Bind Technologies for Mobile Devices,. Salutation.
Consortium, Jun. 6, 1999. http://www.salutation.org/whitepaper/Sal-Lite.PDF.
[11] Brent Miller,. Mapping Salutation Architecture APIs to Bluetooth Service Discovery Layer. Bluetooth Consortium 1.C.118/1.0, Jul. 1, 1999.
[12] Bob Pascoe, Salutation Architectures and the newly defined service discovery protocols from Microsoft and Sun, Salutation Consortium, Jun. 6, 1999. http://www.salutation.org/whitepaper/Jini-UPnP. PDF.
[13] Ryan Troll, Automatically Choosing an IP Address in an Ad-Hoc IPv4 Network,. IETF Draft draftietf-dhc-ipv4-autoconfig-05.txt, Mar. 2, 2000. http://www.ietf.org/internet-drafts/draft-ietf-dhcipv4-autoconfig-05.txt.
[14] Bluetooth Consortium, Specification of the Bluetooth System Core Version 1.0 B: Part E, Service Discovery Protocol (SDP), Nov. 29, 1999. http://www.bluetooth.com/developer/specification/specification.asp.
[15] Bluetooth Consortium,. Specification of the Bluetooth System Profiles Version 1.0 B: Part K:2, Service Discovery Application Profile,. Dec. 1, 1999. http://www.bluetooth.com/developer/specification/specification.asp.
[16] IETF SVRLOC Working Group, Service Location Protocol Home Page,. http://www.srvloc.org.
[17] E. Guttman, C. Perkins, J. Veizades, and M. Day, Service Location Protocol, Version 2,. IETF RFC 2608, June 1999. http://www.ietf.org/rfc/rfc2608.txt.
[18] E. Guttman, C. Perkins, and J. Kempf, Service Templates and Service: Schemes,. IETF RFC 2609, June 1999. http://www.ietf.org/rfc/rfc2609.txt.
[19] Rekesh John,. UPnP, Jini and Salutation. A look at some popular coordination frameworks for future networked devices, California Software Labs, Jun. 17, 1999. http://www.cswl.com/whiteppr/tech/upnp.html.
[20] IETF ZEROCONF Working Group,. Zero Configuration Networking (zeroconf), http://www.ietf.org/html.charters/zeroconf-charter.html.
[21] INS: Intentional Naming System, http://wind.Ics.mit.edu/projects/ins.
[22] The Berkeley Service Discovery Service, http://www.cs.berkeley.edu/˜caerwin/sds-project.html.
[23] R. Droms,. Dynamic Host Configuration Protocol,. IETF RFC 2131, March 1997. http://www.ietf.org/rfc/rfc2131.txt.
[24] Sun Microsystems,. Java 2 Platform Midcro Edition (J2ME) Technology for Creating Mobile Devices, White Paper, May 19, 2000. http://java.sun.com/products/cldc/wp/KVMwp.pdf.
[25] World Wide Web Consortium, Extensible Markup Language (XML)., http://www.w3.org/XML.
[26] Marco Liebsch and Ajoy Singh (editors), “Candidate Access Router Discovery”, Internet Draft draft-ietf-seamoby-card-protocol-06.txt, Internet Engineering Task Force, June 2004.
[27] J. Hodges and R. Morgan, “Lightweight Directory Access Protocol (v3): Technical Specification”, IETF RFC 3377, September 2002.
[28] M. Liebsch, A. Singh, H. Chaskar, D. Funato and E. Shim, “Candidate Access Router Discovery,” Internet-Draft, work in progress, June 2004.
[29] K. Arabshian and H. Schulzrinne, “GloServ: Global Service Discovery Architecture,” First International Conference on Mobile and Ubiquitous Systems: Networking and Services.

### SUMMARY OF THE INVENTION

The present invention improves upon the above and/or other background technologies and/or problems therein.

In order to support the query and response in a most cost effective manner, it is desirable to provide extensibility, flexibility and efficiency. In this regard, two possible candidate solutions include, e.g., XML and TLV. Here, XML provides schema-based semantic querying, but needs to send more bits over the air if one uses, e.g., native XML 1.0 format. On the other hand, TLV provides binary encoding but does not provide a standard query language for semantic query.

In some approaches, to integrate XML and TLV, XML data is converted to TLV. In some illustrative examples set forth below, two methods are described. In this regard, a first method (e.g., Method A) can be applicable to any XML data, and a second method (e.g., Method B) can be applicable to a particular query language. In this regard, XML-based query language typically has three types of queries—e.g., Construction query, Selection query and Boolean query.

According to some embodiments, a method for supporting query and response of a mobile device and a point of attachment in a network, comprising: using XML for a schema-based semantic query and TLV for binary encoding by converting XML data contained in a query result into TLV.

According to some embodiments, a method for network discovery for a mobile device includes performing network discovery queries and/or responses between a mobile device and a point of attachment using a schema-based semantic query with binary encoding. In some embodiments, the method includes using XML for providing a schema-based semantic query, and TLV for providing a binary encoding. In some embodiments, the method includes converting XML data to TLV format. In some embodiments, the method includes employing TLV with SPARQL optimization.

In some embodiments, the method includes converting XML data using an alias-based methodology. In some embodiments, the method further includes a) converting XML namespace names to integers, b) converting XML tag names to integers, c) converting XML attribute names to integers, and/or d) converting ENTRY names to integers. In some examples, the method further includes employing integer mapping, such as, e.g., static and/or dynamic mapping. In some cases, dynamic mapping is carried with data transmitted.

In some embodiments, the method further includes converting XML data employing semantic bundling. In some examples, applicable to a particular query language, the method further includes mapping two or more semantically-related XML tags to a single integer, and taking advantage of the knowledge of the particular query language syntax. In some examples, the method includes employing XML-based query language including construction query, selection query and/or boolean query. In some examples, the method includes employing a construction query for obtaining IEs of a neighboring point of attachment, employing a selection query for obtaining a neighboring point of attachment, and/or employing a boolean query for inquiring if a neighboring point of attachment is of a particular network type, such as, e.g., an 802.11 point of attachment.

The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspect or feature of other embodiments where applicable. The descriptions of aspects, features and/or advantages of particular embodiments should not be construed as limiting other embodiments or the claims.

### BRIEF DESCRIPTION OF THE DRAWINGS

The preferred embodiments of the present invention are shown by a way of example, and not limitation, in the accompanying figures, in which:

FIG. 1 is an illustrative view showing collaborative discovery of local services and network capabilities;

FIG. 2 is an illustrative view showing populating a database using Reporting Agents (RAs);

FIG. 3 is an illustrative a view showing protocol flow for network service discovery;

FIG. 4(A) is an illustrative schematic diagram demonstrating an example of a geo-coordinate based network service discovery architecture;

FIG. 4(B) is an illustrative schematic diagram demonstrating an example of an AP's MAC address based network service discovery;

FIG. 5(A) is an illustration depicting illustrative intra-domain and inter-domain handoff of a mobile node, in which a single radio interface roaming scenario is depicted;

FIG. 5(B) is an illustration depicting illustrative handoff between Cellular and WLAN environments, in which a multiple radio interface roaming scenario is depicted;

FIGS. 6(A) to 6(R) depict aspects related to implementation of a first method according to some preferred embodiments of the invention;

FIG. 7(A) is a schematic diagram showing an example of a construction query for, e.g., obtaining information elements (IEs) of a neighboring network point of attachment;

FIGS. 7(B)(i) and 7(B)(ii) are a schematic diagram (i.e., parts (i) and (ii) of the same diagram) showing an exemplary construction query result;

FIG. 7(C) is a schematic diagram showing an example of a selection query for, e.g., obtaining a neighboring point of attachment;

FIG. 7(D) is a schematic diagram showing an exemplary selection query result;

FIG. 7(E) is a schematic diagram showing an example of a Boolean query for asking if, e.g., a neighboring point of attachment involves 802.11;

FIG. 7(F) is a schematic diagram showing an exemplary Boolean query result;

FIGS. 8(A) to 8(G) depict aspects related to implementation of a second method according to some preferred embodiments of the invention;

FIGS. 9(A)(i) and 9(A)(ii) are a schematic diagram (i.e., parts (i) and (ii) of the same diagram) showing an exemplary construction query result with SPARQL optimization;

FIG. 9(B) is a schematic diagram showing an illustrative selection query result with SPARQL optimization;

FIG. 9(B) is a schematic diagram showing an illustrative Boolean query result with SPARQL optimization;

FIG. 10 is a diagram showing test results demonstrating a comparison of formats according to some illustrative examples;

FIG. 11 is a schematic diagram illustrating types of conversions, including direct conversion and 3-step conversion from binary data to internal data according to some examples;

FIG. 12 is an illustrative table showing exemplary test results related to construction query using an integrated approach according to some illustrative examples; and

FIG. 13 is a diagram showing illustrative data conversion times for some illustrative applications according to a first methodology according to some embodiments of the present invention.

### DISCUSSION OF THE PREFERRED EMBODIMENTS

While the present invention may be embodied in many different forms, a number of illustrative embodiments are described herein with the understanding that the present disclosure is to be considered as providing examples of the principles of the invention and that such examples are not intended to limit the invention to preferred embodiments described herein and/or illustrated herein.

Introduction

In the evolution of wireless networking based on wireless LAN (Local Area Network) and cellular technologies, and as mobility services prevail and people become increasingly mobile, it is more important for a mobile device to be able to find an appropriate point of network attachment that meets the application requirements and the characteristics of the mobile, in a timely, accurate and efficient manner. We refer to such functionality as network discovery.

The network discovery problem discussed in this document is formalized as: obtaining specified network information in the vicinity of a given location based on a set of criteria when a mobile is connected to the IP network from any location. Here:
Network information can be any information that a mobile uses to access networks.

Such information includes, for example, a network attachment point identification (e.g., an L2 address and/or a geographical address of an access point), a MAC type (e.g., “IEEE 802.11g”) of an access point, a security type (e.g., “WPA” or “PANA and IPsec”) supported by an access point, a layer-3 type (e.g., “IPv4 only” or “IPv4/v6 dual stack”), a provider name, or the addresses of a server or an agent (e.g., PANA authentication agents, access routers, SIP servers and Mobile IP home agents).
The location of a mobile or the location which the mobile wants to find information about may be identified (expressed) in different ways. For example, it may be identified by the geographical position, by the identification of the network, or by the addresses of the wireless access points or IP access routers in the networks.

The functionality to discover network information can be used to better support mobility and mobile services. For example, to reduce interruptions to on-going application sessions during a handoff, a mobile device could perform pre-authentication with a target network before it starts the handoff into the target network. To do so, the mobile will need information about the neighboring networks, such as the address of the authentication server in the target network, before the mobile moves into the target network. We will refer to the process in which a mobile discovers information about its neighboring networks as network neighborhood discovery.

A noteworthy issue in network discovery is the discovery database construction problem: how to construct a database of network information in an automated, dynamic and efficient way. Solving this problem is not trivial in a multi-provider environment where a network provider may not be willing to disclose any network information of its own network to other network providers that compete with it, while it may provide detailed network information of its own network to its subscribers for better services. However, there had previously been no practical solution to solve this problem.

There had been protocols designed for service discovery. However, none of those protocols provides support for:
Discovering information about neighboring networks;
Dynamic construction of the discovery databases;
Determining what information to collect and provide to mobiles.

Instead, the existing service discovery mechanisms focused on how to retrieve information already existing in databases. They relied on all local network providers to implement service information servers, which is too strict to be deployed in public networks.

This document describes a new architecture to support network discovery including methods to solve the discovery database construction problem and methods for mobiles to discover information regarding neighboring networks. This architecture is referred to as Application-layer mechanisms for Information Service (AIS). AIS is designed to be extensible enough to support current and future types of network information that may be needed by mobiles. AIS leverages existing protocols as much as possible. Although information about the network elements can have multiple usages, we focus on discovering the information a mobile can use to enable proactive handoff and secured pre-authentication and discuss how these information can be used to support secured and proactive handoff.

AIS Architecture

Information construction process, information retrieval methodology, format of the information stored in the information server are some of the key design factors that need to be looked into while designing the discovery architecture.

Several architectures have been designed for AIS. They can broadly be classified into two main categories: network-assisted and mobile-assisted. In the following sections we describe these architectures and how different functional elements can interact with each other. In each of these architecture alternatives, the mobile will query an AIS server or a peer mobile to find out the information regarding the networking elements in the neighboring networks. The methods of constructing the information database differ in each different architecture. A network-assisted architecture can follow both the distributed and centralized model. The AIS server keeps the information about the network elements in the neighboring networks and will provide the information after getting a query from the mobile. In a centralized model, reporting agents in each network will report the information about the networking elements within the network by using SNMP MIB (Simple Network Management Protocol Management Information Base). The mobile-assisted model is always distributed in nature where the end nodes report the information about the networks they are visiting currently. The way in which the information is retrieved from the AIS server by the mobiles is common for both approaches.

Peer-to-peer based model is another mobile-assisted model where the mobiles act as the information server and provide the information to other mobiles.

Information Server-Based Architecture: Discovery Database Construction

Information server-based architecture can be mobile assisted or network assisted. In the following sections we describe both end-node assisted and network assisted approaches for constructing a network information database.

Mobile-Assisted Approach

A new paradigm is presented for collecting, maintaining, and discovering local services and networking capabilities. The new paradigm will overcome the limitations of the existing approaches described in related work section. The approach uses the following main principles:
Each mobile user can use any proper means available to him/her to discover the network information available in a visited network. Often the user will not need any special assistance from the visited network solely for the purpose of discovering the information the subsequent mobiles may need regarding the visited network. For example, when a mobile connects to a visited network, it will learn the addresses of the access routers and authentication agents in the visited network as part of its normal process for connecting to the visited network. Such information can be reported to the mobile's AIS server which can in turn provide the information to subsequent mobiles before they move into this visited network so that the subsequent mobiles can retrieve the information. The discovery of an available hotspot network and its logon requirements also do not require the local network providers to provide any special assistance.
Each mobile user reports the information it discovers in a visited network to its AIS server. A mobile's AIS server does not have to have any trust relationship with the network that the mobile is currently visiting.
A mobile user's AIS server is responsible for maintaining the information regarding the network information received from its subscribers regarding different networks.
When a subsequent mobile moves into a visited network, it may query its AIS server for local information it needs.

This approach has the following main advantages over existing approaches:
Information mining and discovery will not rely on the local network providers to provide information servers used to provide network information.
Regardless where a mobile user is and which local network it currently uses, the mobile always uses a single protocol to communicate with its AIS server to retrieve network information.
An AIS server only needs to maintain information its own subscribers are interested in. Furthermore, an AIS server only needs to maintain information regarding the locations its own subscribers travel to. This allows the proposed paradigm to be highly scalable.

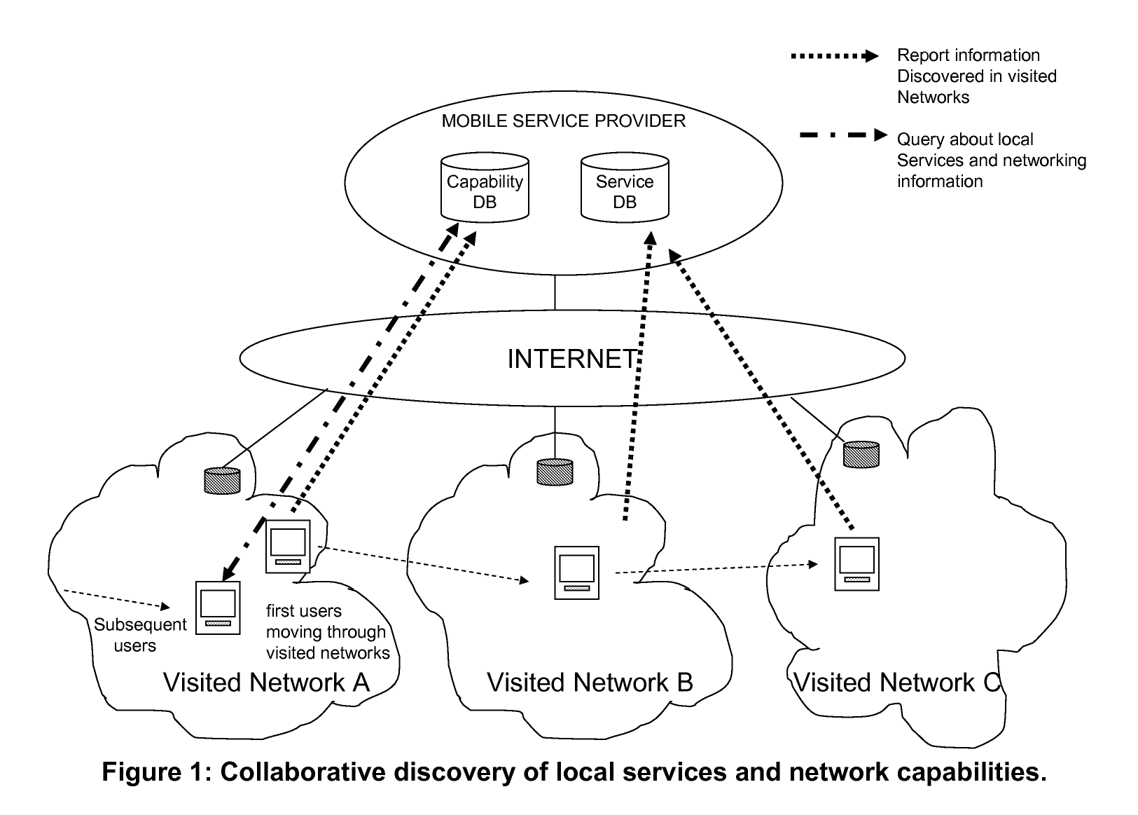

The basic operation of an illustrative proposed collaborative discovery paradigm is illustrated in FIG. 1. It shows how mobile moves between the networks and can update the information about the network elements to a location server commonly shared by a set of networks. This information is stored in the location server using a specific format. With respect to FIG. 1, the figure shows a view demonstrating collaborative discovery of local services and network capabilities.

Network-Assisted Information Discovery

Network assisted information discovery defines three different methods:
These are:

1. Reporting Agent (RA) assisted;

2. AAA assisted;

3. DNS-based approach.

Reporting Agent Assisted

Reporting Agents (RA) are network agents that reside within each network. These are SNMP capable and have the ability to collect the information about the network elements by probing the SNMP MIBs. These reporting agents (RA) will collect the information in the respective domains and populate the location server database for a specific region. This information may include capability set, IP address, geo-coordinates of the respective network elements etc. When a specific network element is attached or becomes operational within a domain, its information is pushed onto the reporting agent (RA), which in turn is sent to the AIS server. Thus, this approach provides a semi-centralized way of populating the AIS server database compared to the end-system assisted approach described previously. The security concerns are less of an issue here as database update is provided by a specific networking agent instead of by the end client and there is a pre-established security association between the RA and the information server.

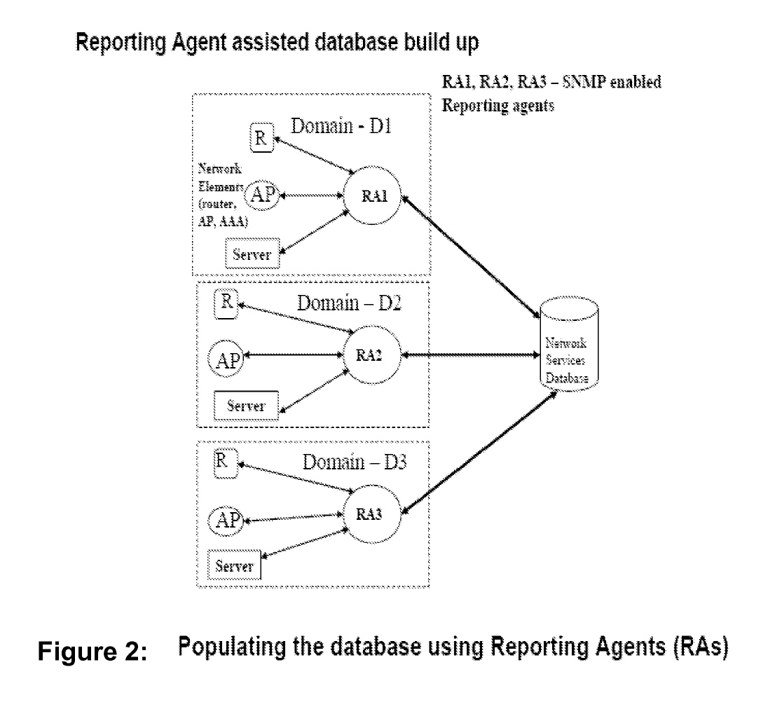

With respect to FIG. 2, the figure shows an example of populating the database using information reported by the Reporting Agents (RAs).

AAA Server Assisted

AAA server assisted information building is another network server assisted approach. Information profile of the mobiles can be saved in the AAA servers as well. Any AAA protocol such as RADIUS and Diameter can be used for populating the network discovery database in a way that a AAA client sends a pair of an address of the mobile and an address of the AAA client to the AAA server. The pair is carried in Calling-Station-Id and Called-Station-Id attributes of the RADIUS and Diameter protocol. The AAA server can collect the information reported from the AAA client and keep track of the mobility pattern of the mobile by recording a list of tuples of (the address of a AAA client, the time the mobile associated with the AAA client, the time the mobile disassociated with the AAA client) for the mobile. This list is then used for constructing the database of neighboring networks among which mobiles can perform handoff.

It is noted that this approach may not be applicable for multi-provider case where a service provider may not want to disclose its topological database to other competing service providers.

DNS Server-Based Approach

One can also use DNS SRV record to find out the list of these network elements instead of using the AIS server. DNS can always populate the services associated with the network elements (routers, APs) and their associated geo-coordinates using DNS's LOC record. Thus one can query a DNS server, give a list of services for a specific domain and the range of geo-coordinates and get a list of network elements that provide these services. A general query may look like this. Given a set of geo-coordinates (R1-R2), find a set of servers that provide a specific set of services such as routing, IEEE 802.11 and AAA. A combination of DNS “SRV” record and geo-location record will help in determining a set of servers in the vicinity.

Note that this approach is not intended for forming arbitrary structured network information database.

Querying the Discovery Database

Many of the operation such as secured pre-authentication, proactive IP address acquisition may be required during a mobile's movement between domains, subnets within a domain. These operations which are usually done after the mobile has moved to the subnet if done ahead of time will help provide the fast-handoff. In order to perform these operation while in the previous domains/subnets it will need to communicate with the next hop routers and severs before the movement is over. Thus a mobile will need to discover the neighborhood information including the APs, routers, DHCP servers and several authentication agents such as PANA authentication agents and in some cases SIP server before moving to the neighboring networks. This information by means of network discovery will help a mobile to perform several types of operation ahead of time such as pre-authentication and proactive IP address assignment. One such mechanism is described below that helps a mobile to discover the neighboring network elements. DNS “SRV” mechanism provides another approach of providing the list of such network elements in the neighboring domains.

Initially a mobile boots up, obtains the IP address and configures itself with other network parameters such as default gateway, and several server parameters etc, It begins to communicate with a corresponding host and at certain point during its communication based on certain policy it determines that the mobile is impending to move. Thus the mobile initiates the AIS process in several different ways. It can always use its location information as the look-up key while making a query. The location information can be the MAC address of an access point, geographic address or any other civic address. When the MAC address of an access point is used as the look-up key, the mobile can obtain the MAC adders either (i) by listening to beacon frames if the mobile is in the radio coverage of the access point or (ii) by recursively performing the query procedures where the recursion starts with specifying the MAC address of an access point known to the mobile based on method (i).

The server gets the query and reports back the list of attributes asked based on the query type. If the client is GPS equipped it can always finds its own location and determines where it plans to move and thus provides a range as part of the information look up and obtain the desired network information.

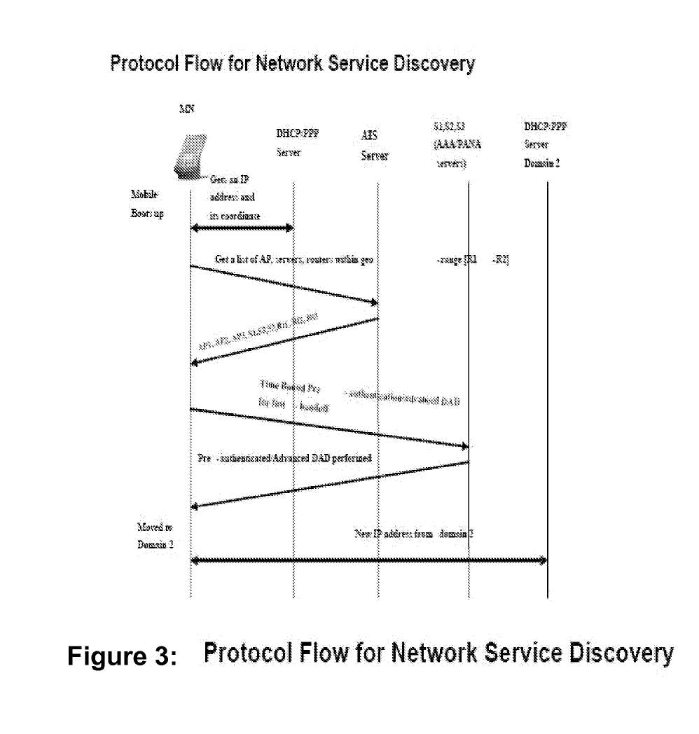

With respect to FIG. 3, the figure shows a protocol exchange and sequence of operation for the network discovery, query and response.

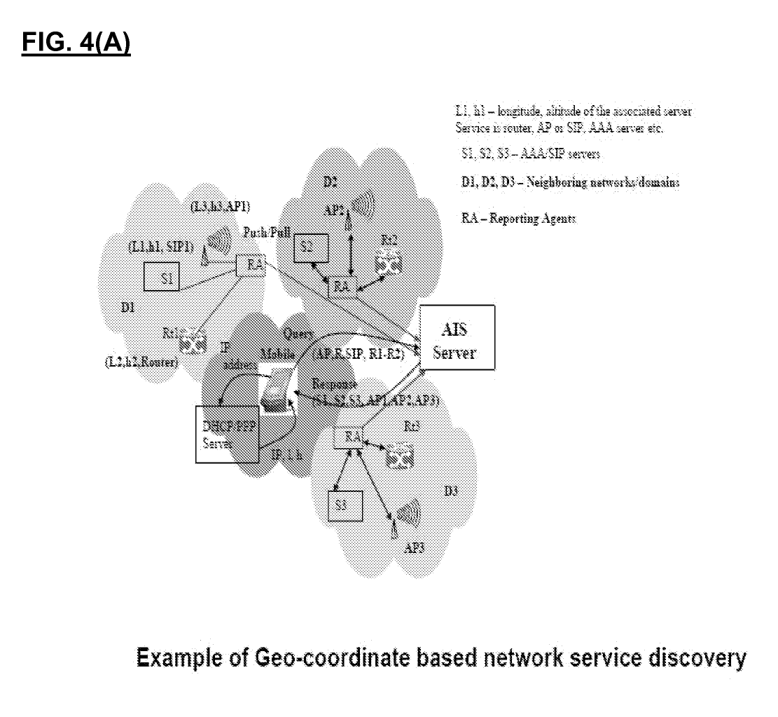

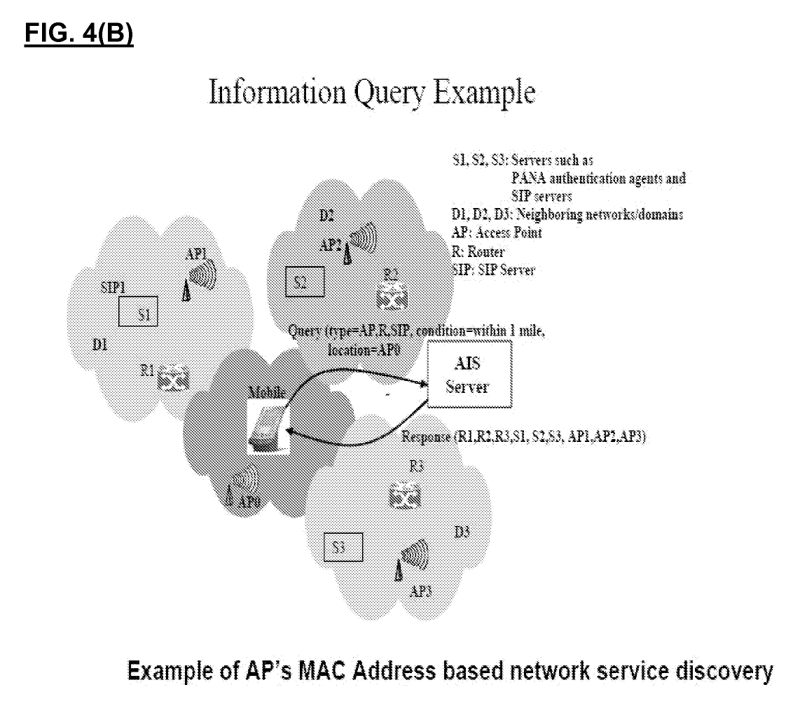

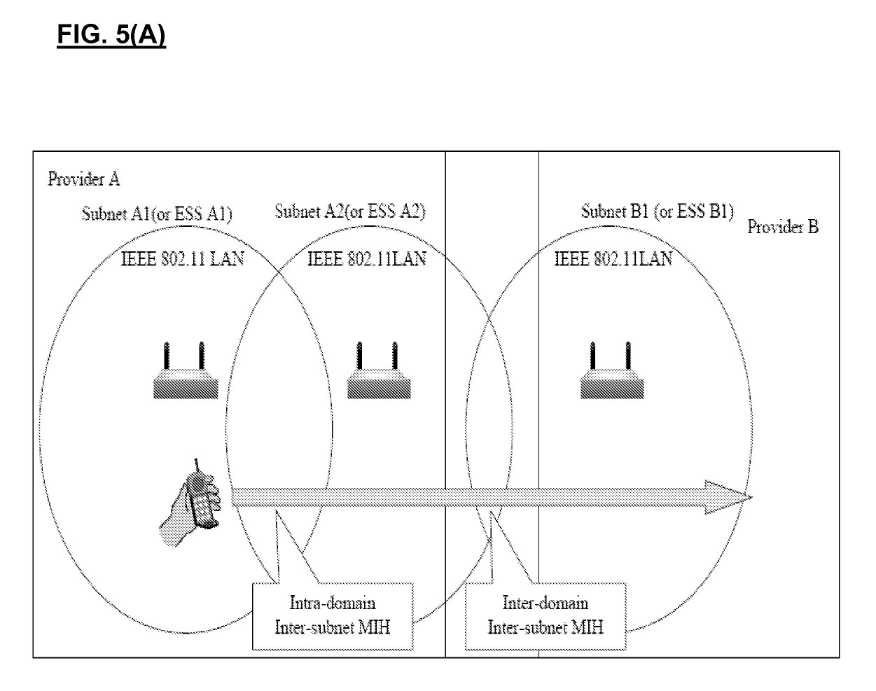

FIGS. 4(A) and 4(B) show some illustrative scenarios of a client discovering the neighborhood servers/routers ahead of time, so that it can get the addresses of the neighboring servers and routers where the mobile has the probability of moving. The range of geo-coordinates of the mobile and the MAC address of an access point and are used as the look-up key for querying in FIGS. 4(A) and 4(B), respectively. Network discovery process will help discover the neighborhood servers, routers and access points ahead of time. By discovering the servers ahead of time pre-authentication can be performed thus expediting the handoff time during the movement. The mobile is currently attached to access point AP0 and has three neighboring networks D1, D2 and D3 where the mobile has the probability to move to. Thus the mobile can query the AIS server with a specific key and can get the information regarding the neighboring APs, servers, and routers in domains D1, D2 and D3 with which it can communicate with to prepare for the secured handoff. Following paragraph shows a sequence of operation after a mobile is booted up.

1) A mobile boots up and connects to a specific Access Point. It obtains an IP address via an IP address configuration procedure through, e.g., DHCP or PPP. The DHCP server or PPP server can have a range of IP addresses. When geo-coordinates are used as the look-up key, the range of geo-coordinates is associated with those IP address and delivered to the mobile together with the IP address in the IP address configuration procedure. It is assumed that each and every mobile may not be GPS equipped. If the mobile knows its own geo-coordinate (R0) and geo-coordinates are used as the look-up key it could also use its geo-coordinate as the look-up key. The IP address of the AIS server for a specific region can be provided by during the IP address configuration procedure or by using DNS.

2) It may also happen that the neighboring cells may belong to different domains. From DHCP configuration, the mobile can find out its current domain (e.g., “att.com” or “sprint.com” etc.). It can also find out the domain names of the neighborhood area using reverse DNS look up from the IP addresses of the network elements that were obtained.

3) The mobile makes a request to the AIS server using its currently attached AP and access router such as following:
a. The request contains a list of network information types about which the mobile wants to retrieve (e.g., type=“PANA authentication server”, “router”) for a specific location (e.g., geo-location R0 or the MAC address of AP0), with specifying a condition (e.g., in the Geo-range [R1-R2] or “within 1 mile”). The condition could be determined based on the velocity of the mobile or mobility pattern.
b. The AIS server returns the list of network information (e.g., IP addresses of servers and routers, MAC addresses of APs that satisfies the condition specified in the request by querying its own database that has been populated separately.
c. From this information I have the list of probable networks that I am likely to move and thus perform a time-bound pre-authentication and/or pro-active IP address acquisition.

With respect to FIG. 4(A), the figure illustrates an example of Geo-coordinate based network service discovery, and with respect to FIG. 4(B), the figure illustrates an example of AP's MAC Address based network service discovery.

There are additional features for database querying that AIS can provide. For example, the criteria used for choosing network information to be provided for a mobile can be either specified by the mobile or by the AIS server or by both entities. When the AIS server specifies the criteria, the profile of the mobile may be used as the criteria. In this case, the AIS may provide detailed network information for mobiles subscribing to a high-class AIS service than mobiles subscribing to a low-class AIS service.

Peer-to-Peer Model

A peer-to-peer model does not depend upon the information server for information storage and retrieval. Instead, each mobile terminal will serve as an information server. We describe two peer-to-peer-based models, such as proactive broadcast and scoped multicast.

In the proposed peer-to-peer model:
Each mobile moving between the networks keeps the information about just visited networks in its local cache for a specific duration;
Each neighbor of a mobile will have different information about the neighboring networks.

Applicability to Secure Pre-authentication

Network discovery mechanism described here can help all these kinds of handovers between different access networks, including, e.g., the following scenarios:
Handover between 802.11 and 802.3 networks;
Handover between 802.3 and 802.16 networks;
Handover between 802.11 and 802.16 networks;
Handover between 802.11 and 802.11 networks, across ESSs;
Handover between 802.3 and Cellular networks;
Handover between 802.11 and Cellular networks; and/or
Handover between 802.16 and Cellular networks.

In the preferred embodiments, the discovery approach will be applicable to both heterogeneous and homogeneous handoff scenarios.
Movement among homogeneous Systems
   Single interface e.g., 802.11, between ESS)
   Multi interface (e.g., 802.11, between ESS)
Movement among heterogeneous networking systems is always dual mode
   802.3, 802.11
   802.11, CDMA/GSM (Cellular)
   Between Cellular Networks (CDMA, GSM)
   802.11, 802.16, 802.20
   802.11, Circuit-switched

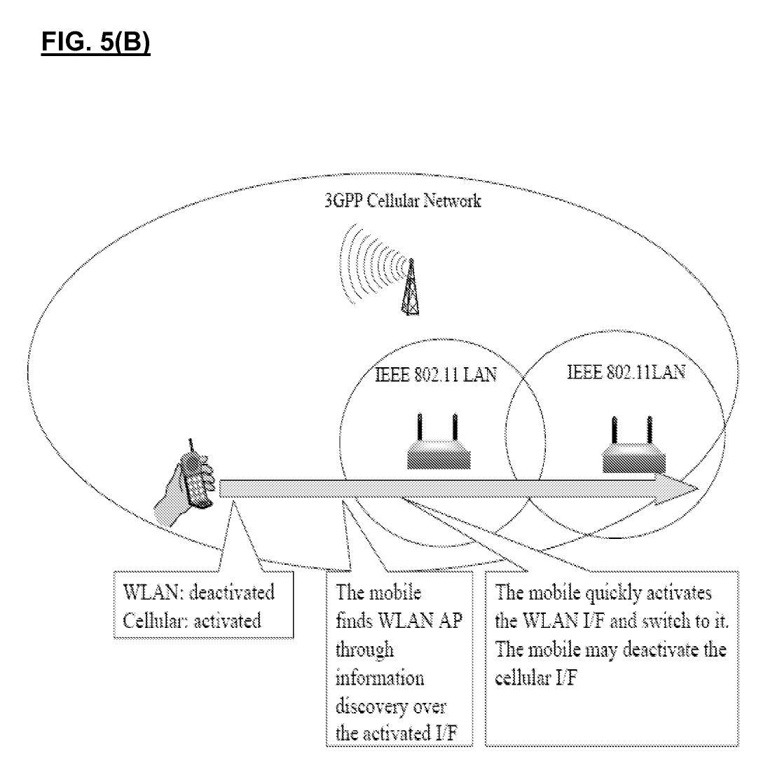

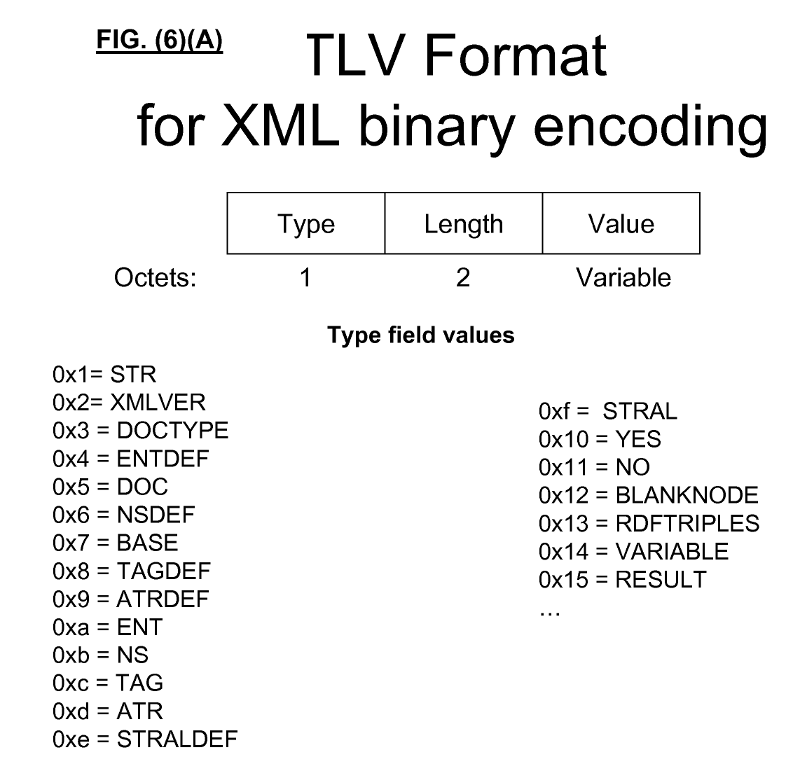

For illustration, FIG. 5(A) shows an illustrative intra-domain and inter-domain handoff of a mobile node, in which a single radio interface roaming scenario is depicted, and FIG. 5(B) shows an illustrative handoff between Cellular and WLAN environments, in which a multiple radio interface roaming scenario is depicted.

MIH Function Under 802.21:

The primary role of the MIH Function is to facilitate handoffs and provide intelligence to the network selector entiity or the mobility management entity responsible for handover decision as described by other standards or proprietary implementations. The MIH Function aids the network selector entity with the help of Event service, Command service and Information service. The network selector entity and the handover policies that control handovers are outside the scope of MIH Function. Description of specific handover policies and the details of network selector entity are outside the scope of 802.21 standards as well.

The IEEE 802.21 specification defines services that enhance handovers between heterogeneous access links. This is achieved through facilitating handover process by providing link layer intelligence relevant in handover detection, handover initiation and candidate link selection by MIH user.
A Media Independent Event Service (MIES) which provides event classification, event filtering and event reporting corresponding to dynamic changes in link characteristics, link status, and link quality.
A Media independent Command Service (MICS) which enables MIH user to manage and control link behavior relevant to handovers and mobility.
Media Independent Information Service (MIIS) which provides details on the characteristics and services provided by the serving and surrounding networks. The information enables effective system access and effective handover decisions.
The above services are supported by the Media Independent Handover Function (MIHF) to facilitate a MIH user in mobility management and handover process. The MIH Function provides convergence of link-layer state information from multiple heterogeneous access technologies into a unified presentation to the upper layers of the mobility-management protocol stack.

The 802.21 draft specification is based on, among other things, the following general design principles.
The Media Independent Handover (MIH) Function is logically defined as a shim layer in the mobility-management protocol stack of both the mobile node and the network elements that provide mobility support. MIH is a helper and facilitator function which helps in handover decision making. Upper layers make handover decisions and link selection based on inputs and context from MIH. Facilitating the recognition that a handover should take place is one of the key goals of MIH Function. Discovery of information on how to make effective handover decisions is also a key component.
MIH Function provides abstracted services to higher layers. From that perspective MIH offers a unified interface to the upper layers. The service primitives exposed by this unified interface are independent of the technology specific protocol entities of the different access networks. The MIH Function communicates with the lower layers of the mobility-management protocol stack through technology-specific interfaces. The specification of the MIH interfaces with the lower layers generally does not fall within the scope of 802.21. Such interfaces are already specified as service access points (SAPs) within the standards that pertain to the respective access technologies, such as IEEE 802.1, IEEE 802.3, IEEE 802.11, IEEE 802.16, 3GPP and 3GPP2.

Media Independent Information Service (MIIS) provides a framework and corresponding mechanisms by which a MIHF (Media Independent Handover Function) entity can discover and obtain network information existing within a geographical area to facilitate the handovers. MIIS primarily provides a set of information elements (IEs), the information structure and its representation and a query/response type of mechanism for information transfer. This contrasts with the asynchronous push model of information transfer for the event service. The information may be stored within the MIH functional (MIHF) entity or maybe present in some information server from where the MIH in the station can access it.

The information can be made available via both lower as well as higher layers. Information can be made available at L2 through both a secure and an insecure port. The structure and definition of a schema can be represented in a high level language such as XML.

The Information service also provides access to static information such as neighbor reports. This information helps in network discovery. The service may also provide access to dynamic information which may optimize link layer connectivity with different networks. This could include link layer parameters such as channel information, MAC addresses, security information, etc. Information about available higher layer services in a network may also help in more effective handover decision making before the mobile terminal actually attaches to any particular network.

The Media Independent Information service specifies a common (or media independent) way of representing this information across different technologies by using a standardized format such as XML or ASN.1

MIIS provides the ability to access this information about all heterogeneous networks in a geographical area from any single L2 network, depending on how the 802.21 MIIS service is implemented. MIIS either relies on existing access media specific transports and security mechanisms or L3 transport and L3 security mechanisms to provide access to the information. Typically, in a heterogeneous network composed of multiple media types, it is the handover decision module or higher layer mobility management will collect information from different media types and assemble a consolidated view to facilitate its inter-media handover decision.

Some networks such as the cellular networks already have an existing means of detecting a list of neighborhood base stations within the vicinity of an area via the broadcast control channel. Other IEEE groups define similar means and supports clients in detecting a list of neighborhood access points within the vicinity of an area via either beaconing or via broadcast of MAC management messages. The Media Independent Information Service (MIIS) provides a unified framework to help the higher layer mobility protocols (HLMP) across the heterogeneous network environment to facilitate the client's discovery and selection of multiple types of networks existing within a geographical area. In the larger scope, the macro objective is to help the higher layer mobility protocol to acquire a global view of the heterogeneous networks to facilitate seamless handover when roaming across these networks.

Schema Design

AIS provides a framework that uses the existing standards for access points and routers without the need to make any changes in the routers and access points. In some embodiments, a database schema will use XML, RDF and SOAP. RDF database can be constructed in a distributed fashion to be able to scale to large number of networks. RDF can also handle arbitrary interconnected data structure while LDAP handles tree-based data structure only. RDF can provide querying schema as well as data themselves.

Information Service Schema:

A schema defines structure of information. A schema is used in the 802.21 information service to define the structure of each information element as well as the relationship among different information elements supported. The 802.21 information service schema needs to be supported by every MIH Function that implements the MIIS to support flexible and efficient information queries. The 802.21 information service defines the various information elements and their structure. The various IEs represent information about lower layers of network stack as well as about higher layer services available in different access networks. A schema is defined by a language and can be represented in multiple ways. Examples include Resource Description Framework (RDF) which is based on, e.g., XML, ASN.1 which is used in 802 MIBs, Variants or a simple TLV representation of different information elements.

The MIIS schema is classified into two major categories. Basic schema that is essential for every MIH to support and Extended schema that is optional and can be vendor specific.

RDF Schema Representation:

This section gives an example of schema using Resource Description Framework (RDF). See 3GPP TS 23.234, “3GPP system to Wireless Local Area Network (WLAN) inter-working; System description” (Reference [8]). RDF uses SPARQL (see 3GPP TS 23.060, “General Packet Radio Service (GPRS); Service Description; Stage 2” (Reference [7])) as a query language for querying information. Both RDF schema and SPARQL are represented in XML. An RDF schema defines the structure of set of expressions, where the underlying structure of any expression is a collection of triples, each consisting of a subject, a predicate and an object. XML syntax for RDF called RDF/XML is defined in GPP TR 43.901 “Feasibility Study on Generic Access to A/Gb Interface” (Reference [9]).

RDF has, e.g., the following advantages:
Supports both hierarchical and non-hierarchical information structure.
Allows for flexible data query
Allows for distributed schema definition
Easier way to change the schema definition

As discussed below, the RDF schema definition for MIIS has two parts: the basic and the extended schema. The basic schema is not supposed to be updated. An MIH entity is typically pre-provisioned with the basic schema for ease of implementation of schema-based query. In scenarios where the basic schema is not pre-provisioned methods such as DNS query may be used to access the location (FQDN) of the basic schema.

Unlike the basic schema, the extended schema is expected to be updated periodically, e.g., when a new link-layer technology is introduced. The extended schema can be retrieved from the specified URL via the IEEE 802.21 information service using the schema query capability described in Section 8.5.3 of IEEE 802.21 Media Independent Handover Services21-05-xxxx-00-0000-One_Proposal_Draft_Text without any pre-provision of such extended schema. The URL of the extended schema can also be obtained via the schema URL query capability described in said section 8.5.3. Alternatively, a DNS query may be used for finding out the location (FQDN part) of extended schema. The extended schema is defined as an extension of the basic schema and includes data structure and relationship of media-specific or higher-layer information. In that sense extended schema is the complement of basic schema.

RDF/XML Schema Definition for IEEE 802.21 Information Service

The RDF/XML schema definition for IEEE 802.21 information service has two parts, i.e., the basic schema and the extended schema. Every MIH entity should be pre-provisioned with the basic schema. The basic schema is not supposed to be updated. The rest of the RDF/XML schema is the extended schema. Unlike the basic schema, the extended schema is supposed to be updated, e.g., when a new link-layer technology is introduced, and an MIH entity does not need to be pre-provisioned with the extended schema. Instead, the extended schema can be retrieved via the information service using, e.g., the schema query capability described in the prior patent applications incorporated herein by reference above.

Preferred Embodiments Integrating XML and TLV

In some preferred embodiments, both XML and TLV format are used for information discovery. The size of query and response obtained via RDQL is much larger than the size of TLV query and response. However, if basic schema is changed to a more flat structure, then the size of query and response will be reduced. On the other hand, XML-based query provides more extensibility and flexibility.

In order to reduce, e.g., the number of bytes transmitted (e.g., wirelessly over the air), a compressed version of XML can be used (such as, e.g., gunzip). By using a compressed version of XML, during information query, discovery time can be reduced to some extent. Some examples of using integration of XML and TLV are described below.

In order to support the query and response in a most cost effective manner, it is desirable to provide extensibility, flexibility and efficiency. In this regard, two possible candidate solutions include, e.g., XML and TLV. Here, XML provides schema-based semantic querying, but needs to send more bits over the air if one uses, e.g., native XML 1.0 format. On the other hand, TLV provides binary encoding but does not provide a standard query language for semantic query.

In some approaches, to integrate XML and TLV, XML data is converted to TLV. In some illustrative examples set forth below, two methods are described. In this regard, a first method (e.g., Method A) can be applicable to any XML data, and a second method (e.g., Method B) can be applicable to a particular query language. In this regard, XML-based query language typically has three types of queries—e.g., Construction query, Selection query and Boolean query.

With respect to these queries, a Construction query is used to fetch the sub-paragraph, Selection query is used for selected bindings, and Boolean query is used for “yes” or “no.”

As indicated above, according to the preferred embodiments of the invention, two methods for converting XML data (e.g., XML 1.0 data) to TLV format are provided. In the following discussion, the two methods and XML 1.0 are compared in terms of number of encoded octets and processing time for the above-noted three typical query types.

Information Service Properties

According to some preferred embodiments, Information Service representation and Information query/exchange shall preferably have the following features (e.g., IS requirements, except for transport/protocol requirements):
Extensible:
   The specification shall preferably be able to support not only existing PHY/MAC technologies, but also any future PHY/MAC technology, without changing the 802.21 specification itself every time a new PHY/MAC technology is invented.
Flexible:
   The specification shall preferably be able to support various types of queries to be useful for different handover mechanisms, protocols, algorithms and policies.
Efficient:
   The specification shall preferably be able to (a) avoid unnecessary information query/exchange (query efficiency) and (b) have less information encoding overhead (encoding efficiency).

According to the preferred embodiments, an advantageous approach is provided that involves a schema-based semantic query with binary encoding:
In preferred embodiments, the schema provides extensibility.
In preferred embodiments, the semantic query provides flexibility and query efficiency.
In preferred embodiments, the binary encoding provides encoding efficiency.

In preferred embodiments, these functionalities above can be achieved by integrating XML and TLV, in a manner to achieve the best of each solution.

In this regard, in some embodiments, the solutions involve that:
XML provides a schema-based semantic query. However, XML needs to send more bits wirelessly over the air if we use, e.g., native XML 1.0 format (note: a proposed solution in 802.21 draft involves RDF/XML+SPARQL).
TLV provides binary encoding. However, TLV does not provide a standard query language for semantic query.

In some preferred embodiments, XML and TLV can be integrated as follows. In particular, according to some embodiments, a potential approach involves an XML binary representation. According to such potential approaches, the XML data contained in a query result is converted into TLV.

In some preferred embodiments, in order to convert the XML data, an alias-based (simple and lightweight) method is employed, which includes, e.g.: a) converting XML namespace names to integers; b) converting XML tag names to integers; c) converting XML attribute names to integers; and d) converting ENTRY names to integers.

In some preferred embodiments, integer mapping can be employed that is either static or dynamic. For example, static mapping can be, e.g., for pre-defined tags and/or attributes. On the other hand, dynamic mapping can be, e.g., for other tags, attributes and/or namespaces. In some embodiments, dynamic mappings can be carried with data and/or provided via an out-band mechanism.

In some of the preferred embodiments, two exemplary conversion methods (e.g., Method A and Method B below) can be employed, as set forth below.

Method A: In a first method, that is, e.g., applicable to any XML data, the following steps are preferably employed.
In a first step, an alias-based conversion is performed which includes:
   Converting XML namespace names to integers;
   Converting XML tag names to integers;
   Converting XML attribute names to integers;
   Converting ENTRY names to integers.
In a second step, dynamic integer mapping is performed which includes:
   Mappings that are preferably carried with data.

Method B: In a second method, that is, e.g., applicable to a particular query language, the following steps are preferably employed.
In a first step, semantic bundling is performed which includes:
   Mapping two or more semantically-related XML tags to a single integer for further optimization.
   Taking advantage of the knowledge of the query language syntax.
In a second step, applying Method A for other operations.

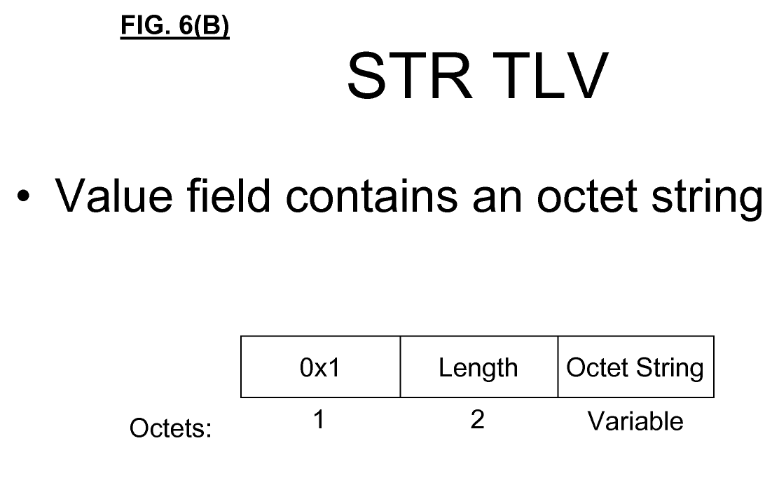

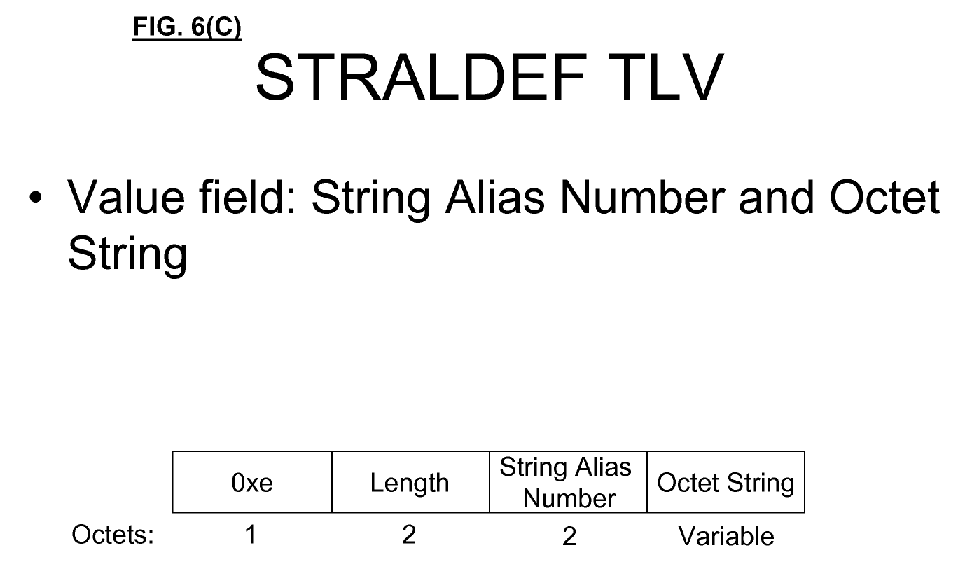

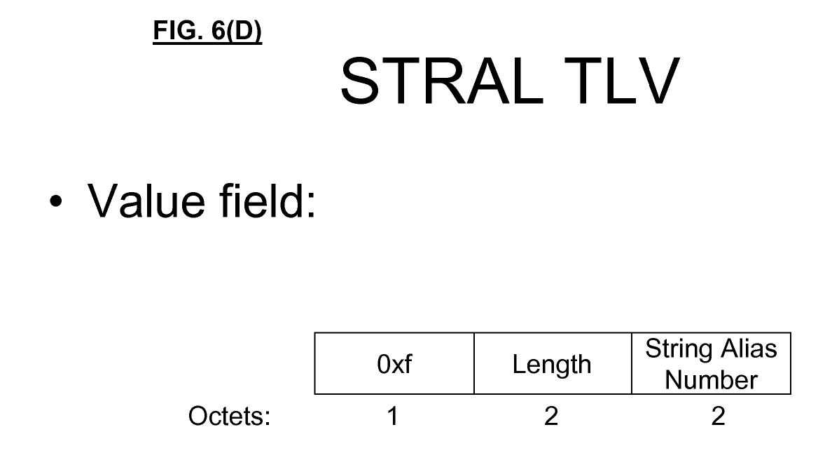

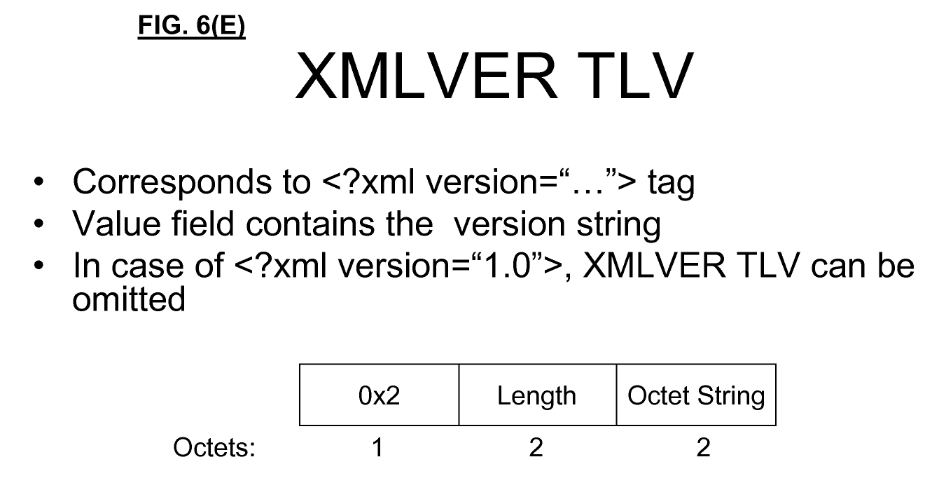

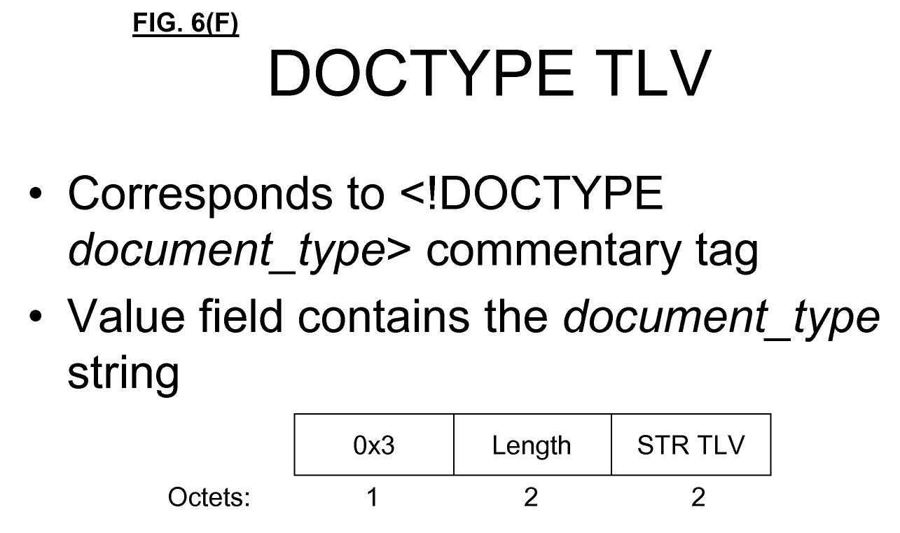

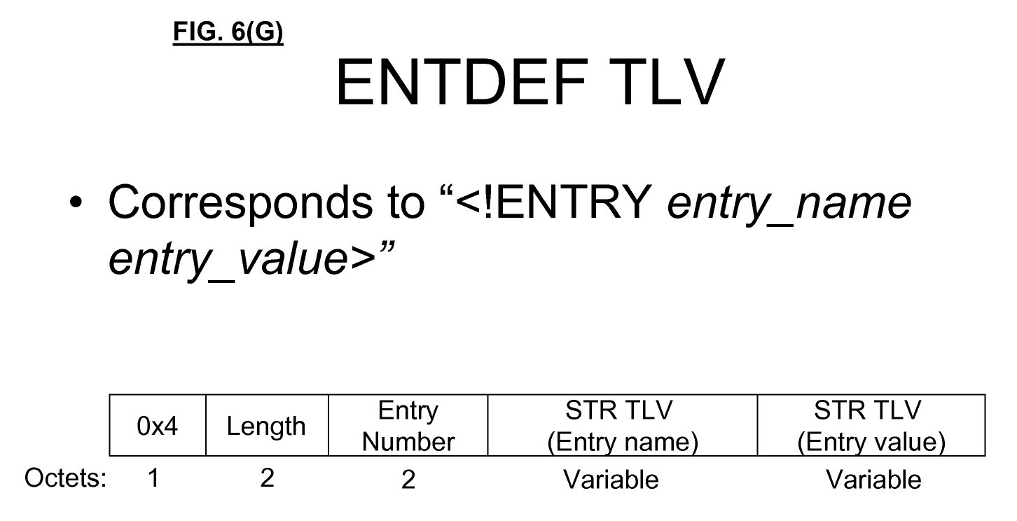

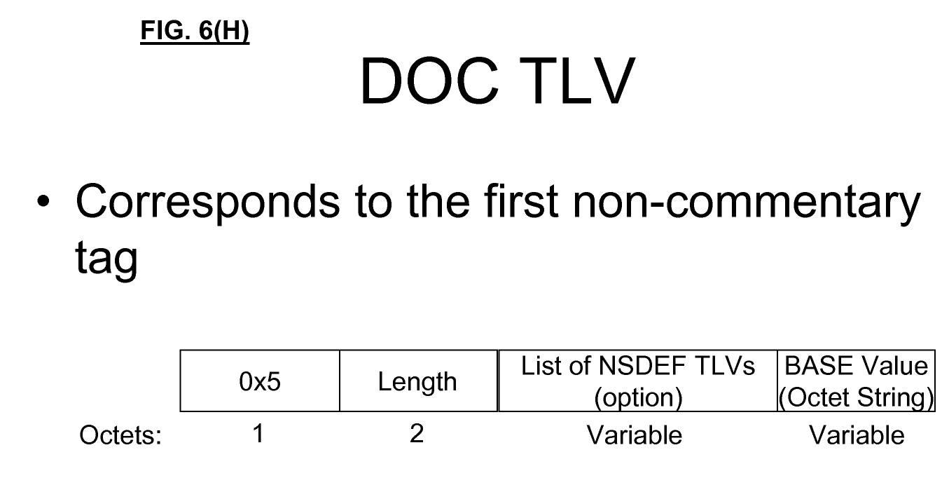

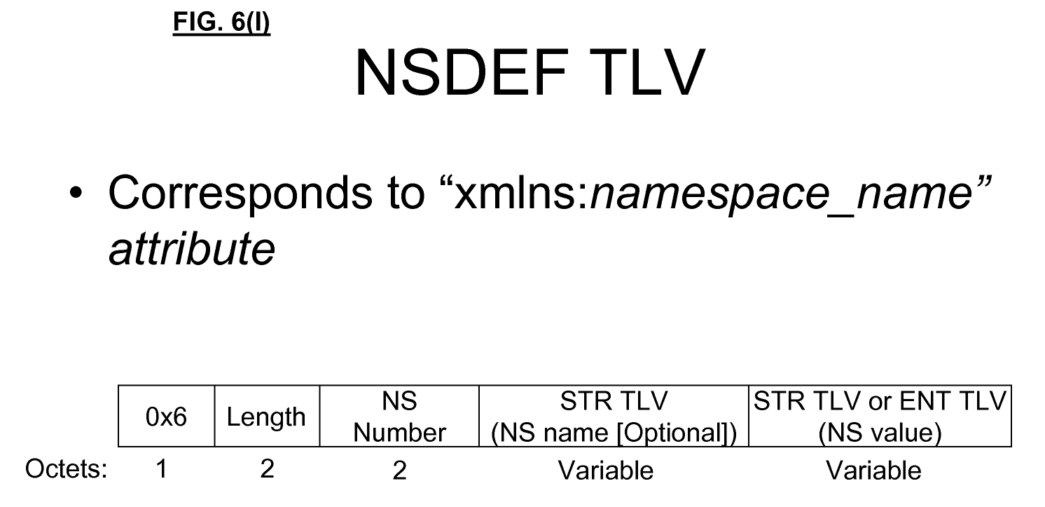

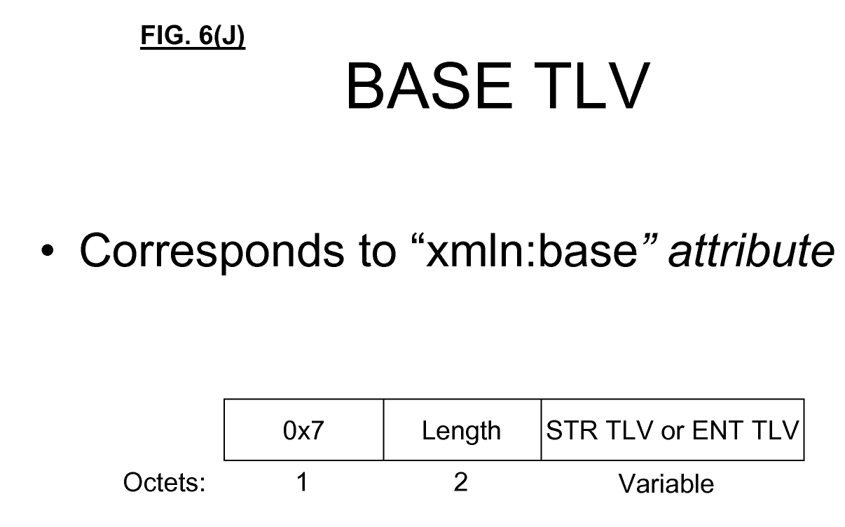

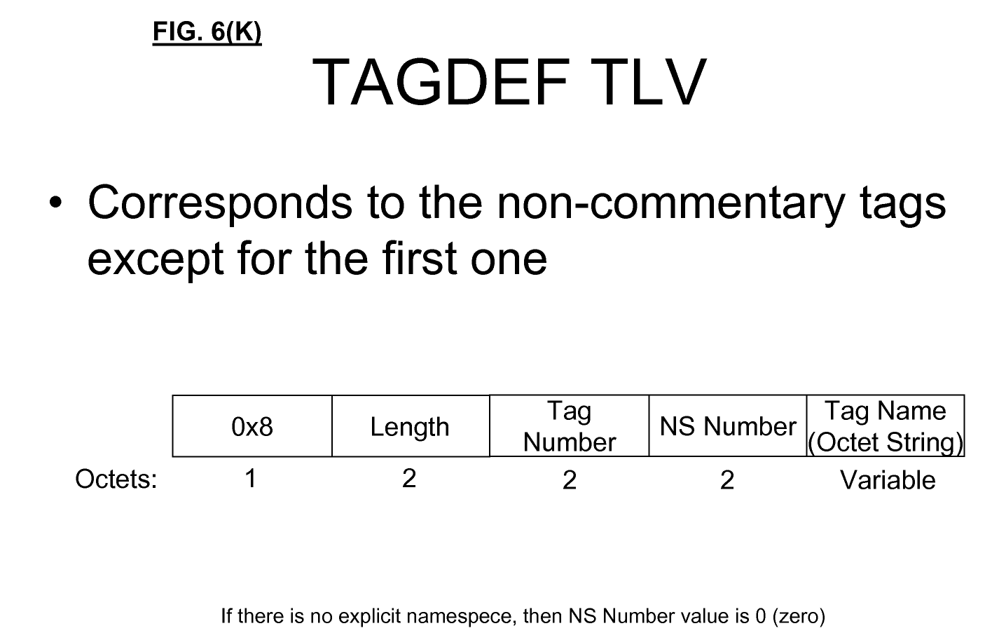

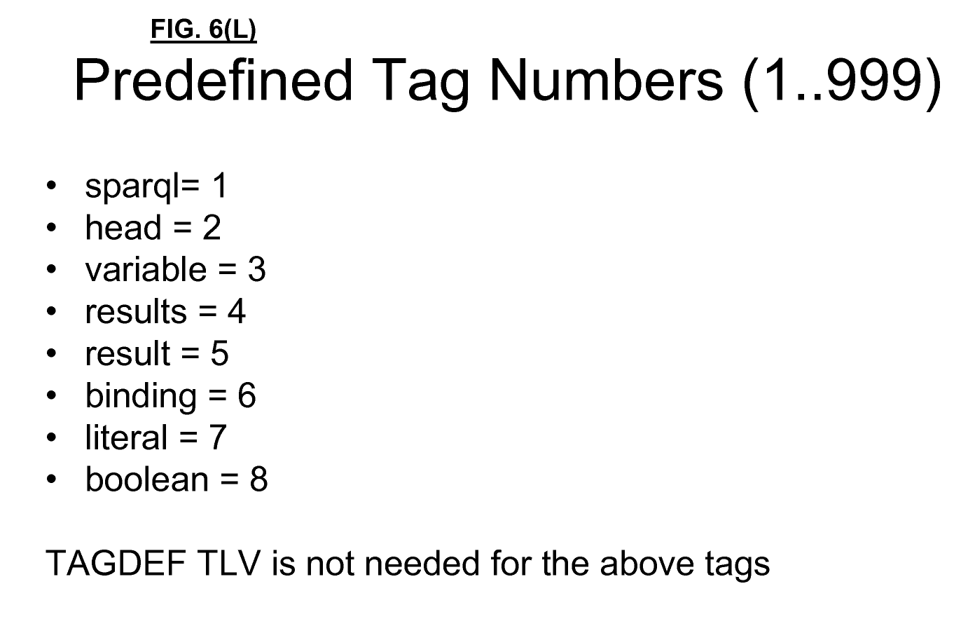

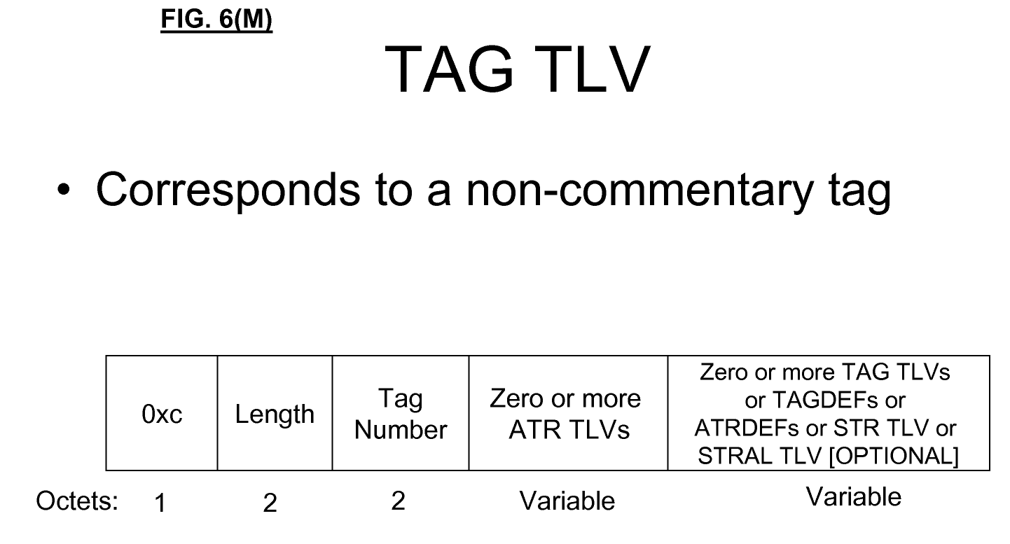

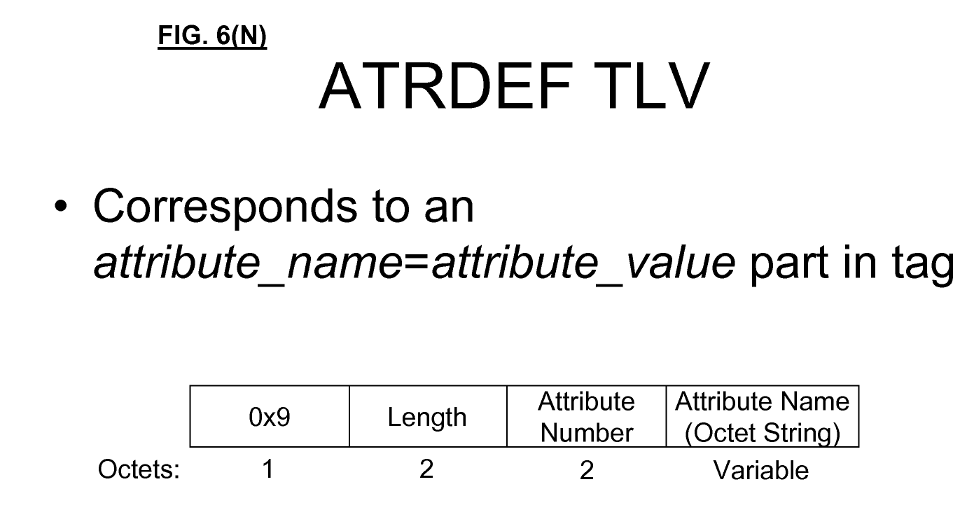

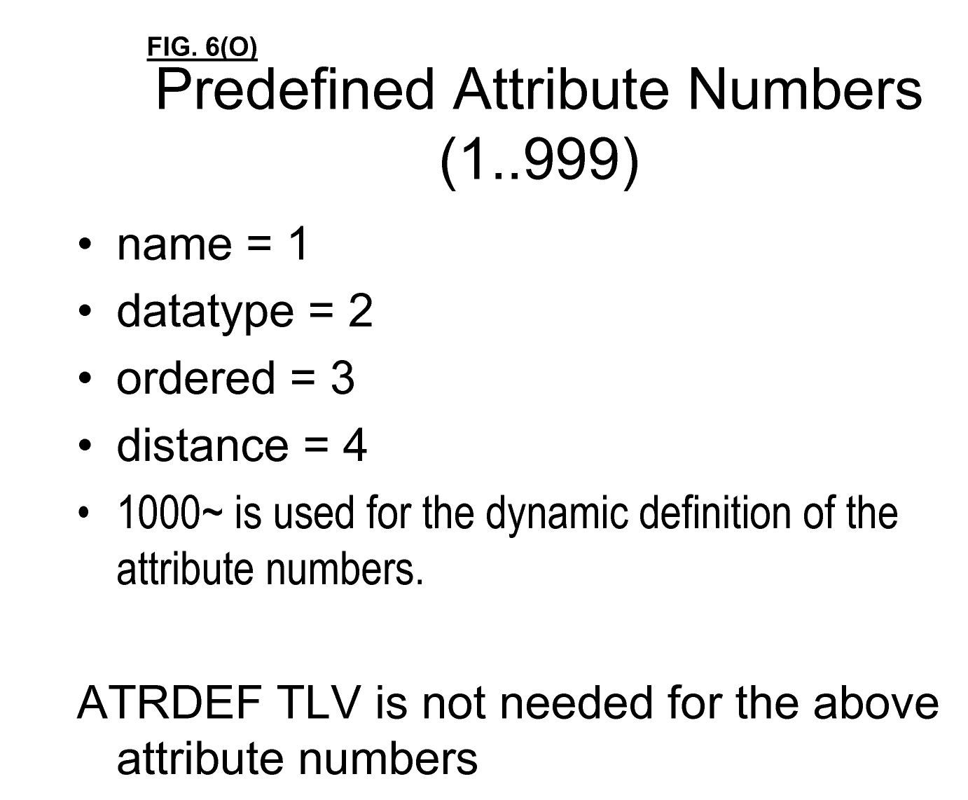

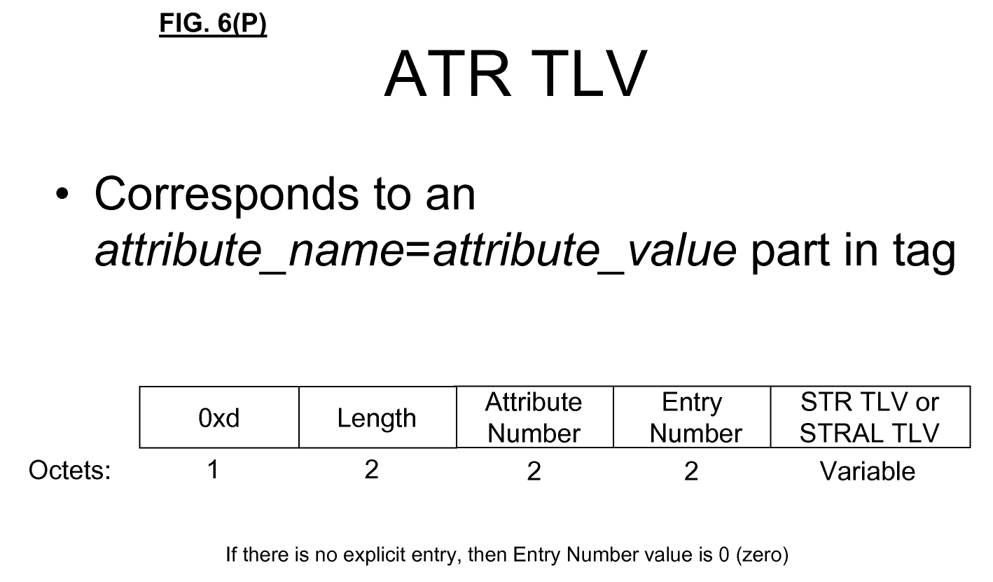

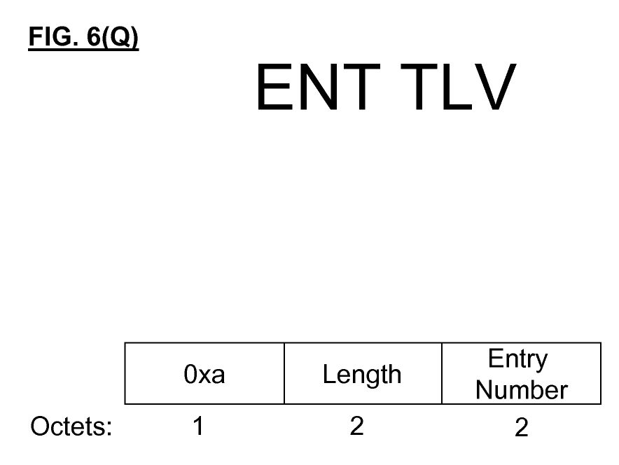

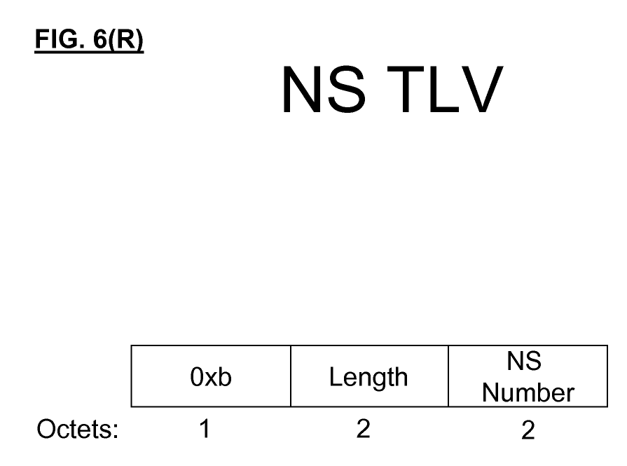

According to some illustrative and non-limiting embodiments, some aspects related to implementation of Method A are shown in FIGS. 6(A) to 6(R).

With respect to types of queries used in XML, XML-based query language, e.g., SPARQL, has three types queries: Construction query; Selection query and Boolean query. Notably, there are two types of XML data contained in, e.g., SPARQL query results depending on these query types.
Construction query: used for sub-graph fetch.
   For Construction queries, RDF triples in XML are returned.
Selection query: used for selected bindings.
   For Selection queries, selected bindings (e.g., pairs of variable names and values) in XML are contained and returned
Boolean query: Used for binary answer
   For Boolean queries, “yes” or “no” in XML is contained and returned.

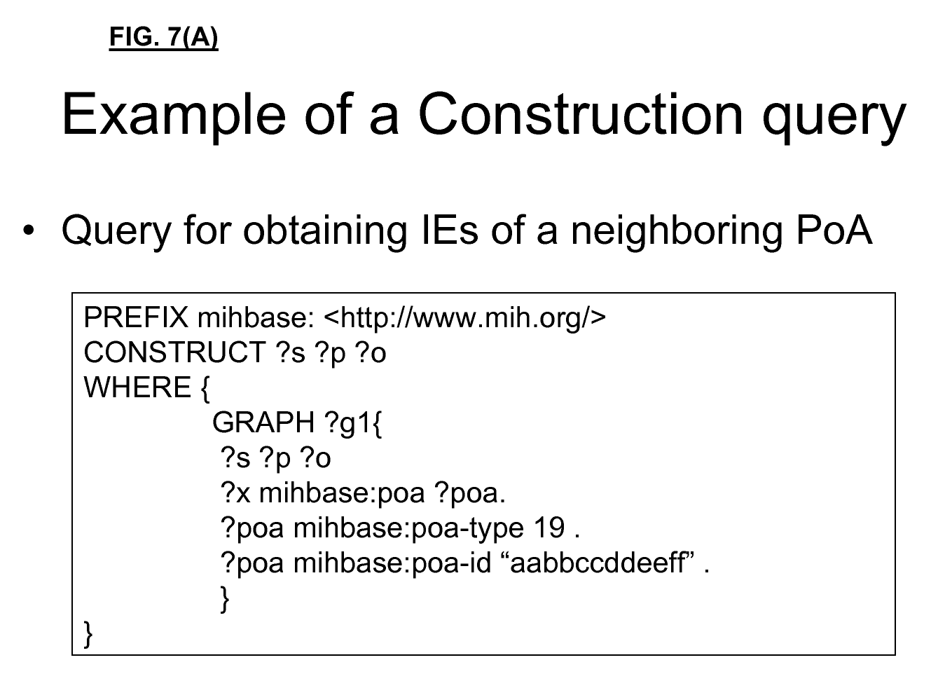

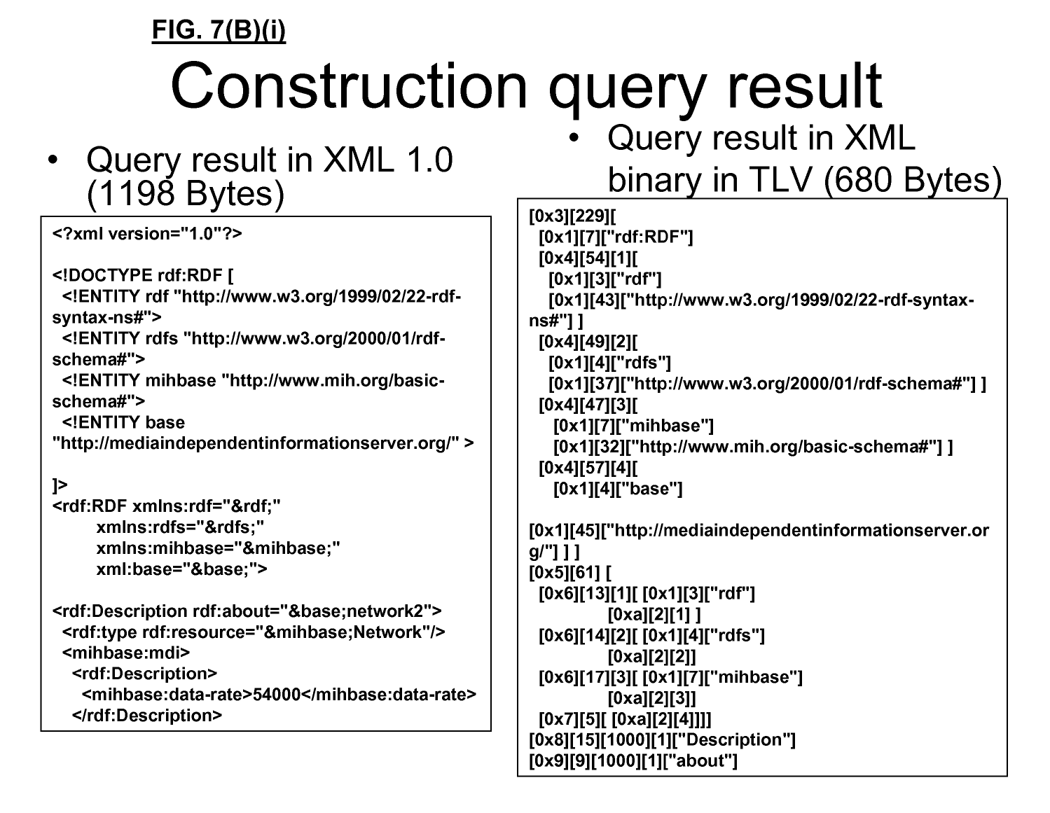

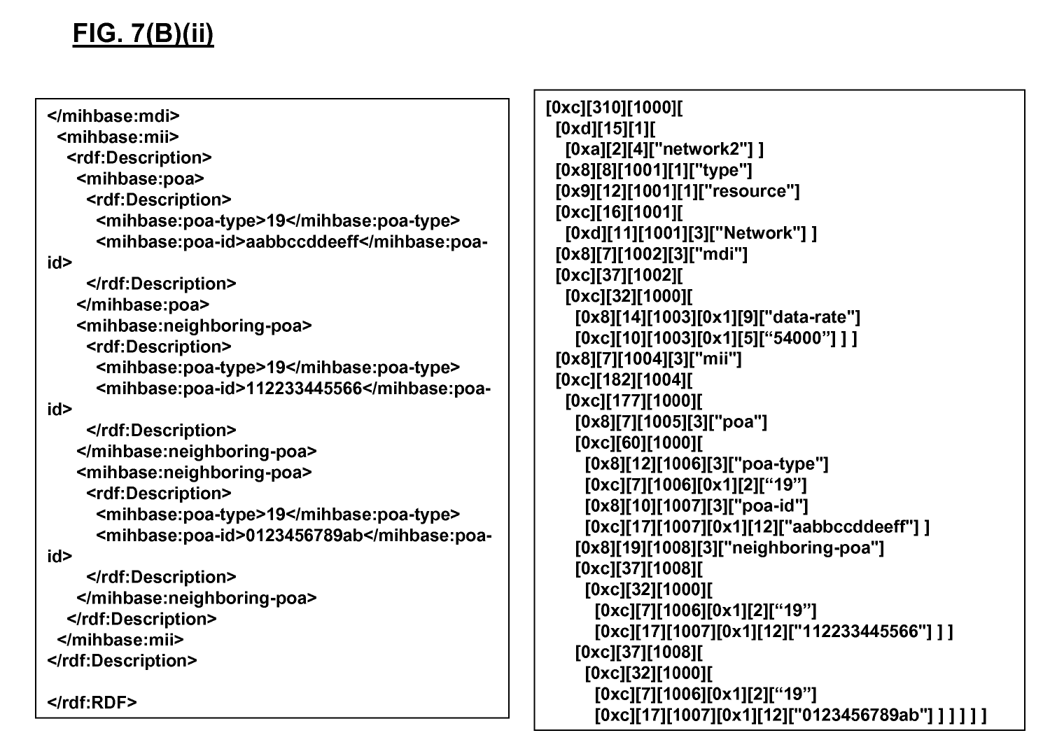

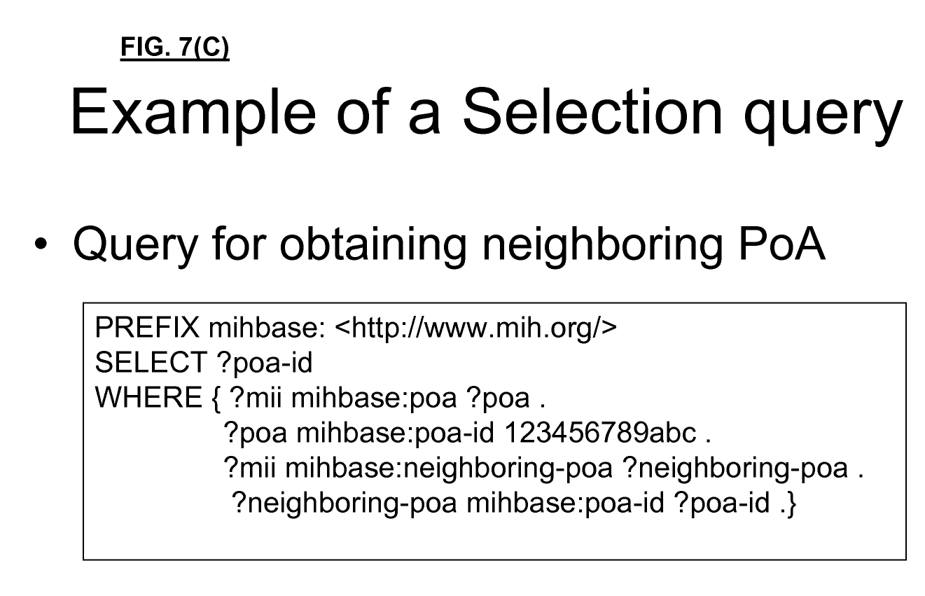

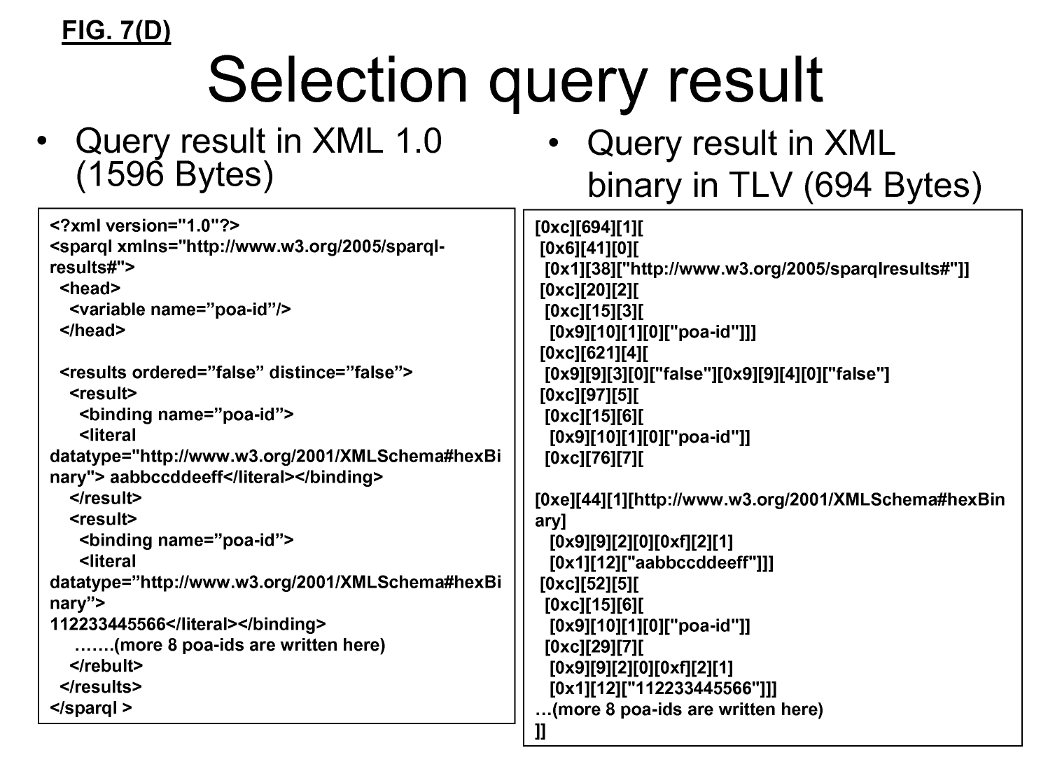

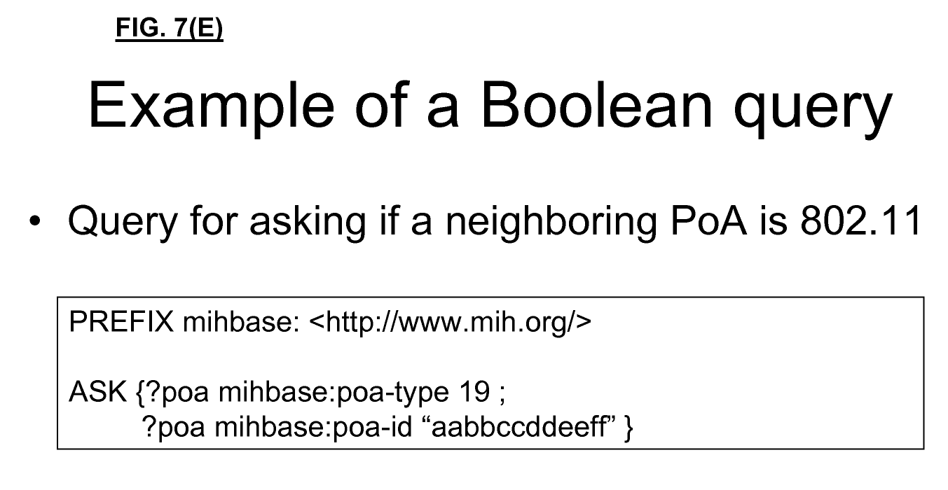

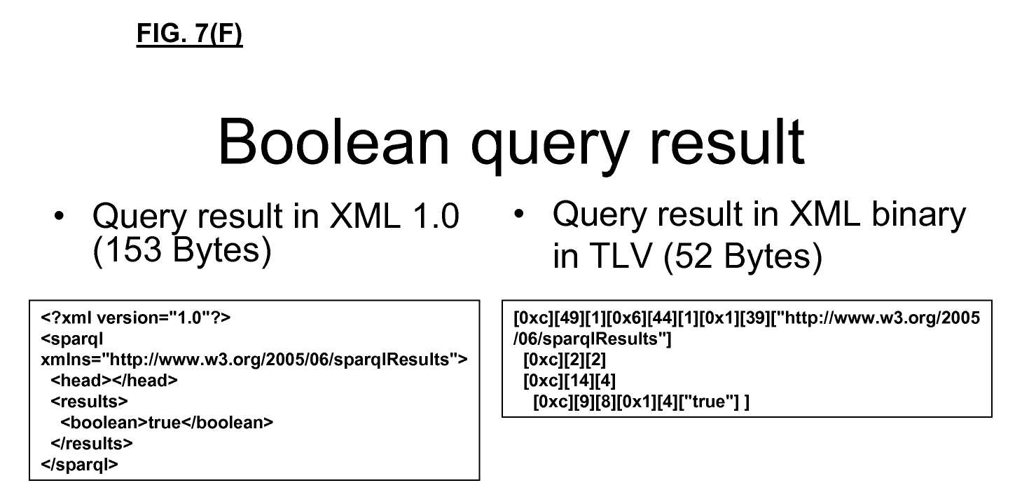

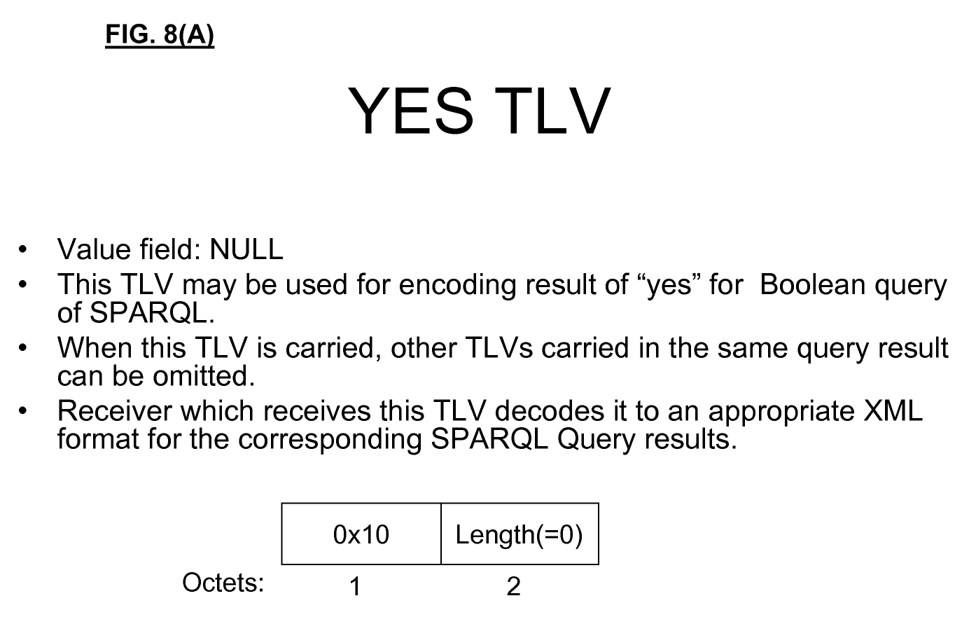

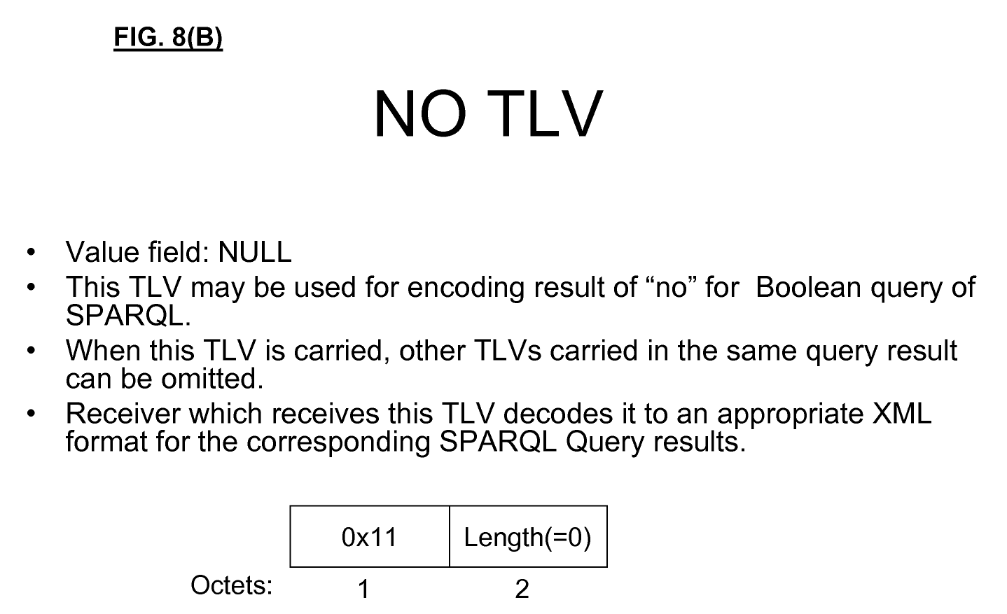

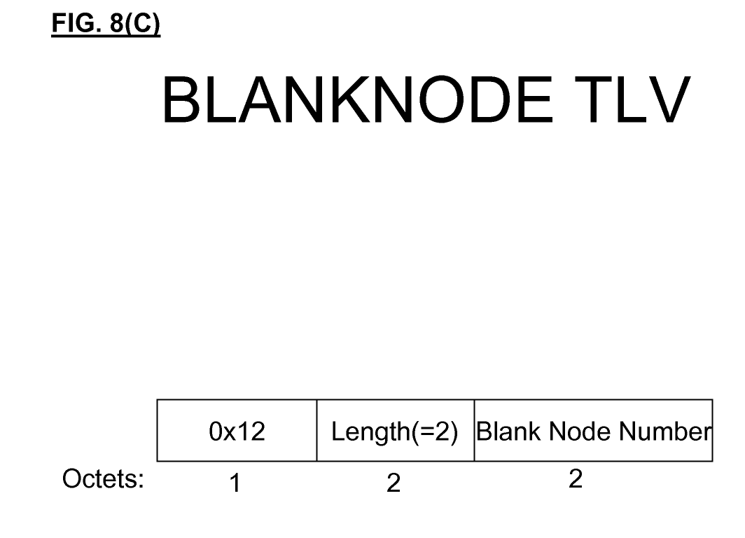

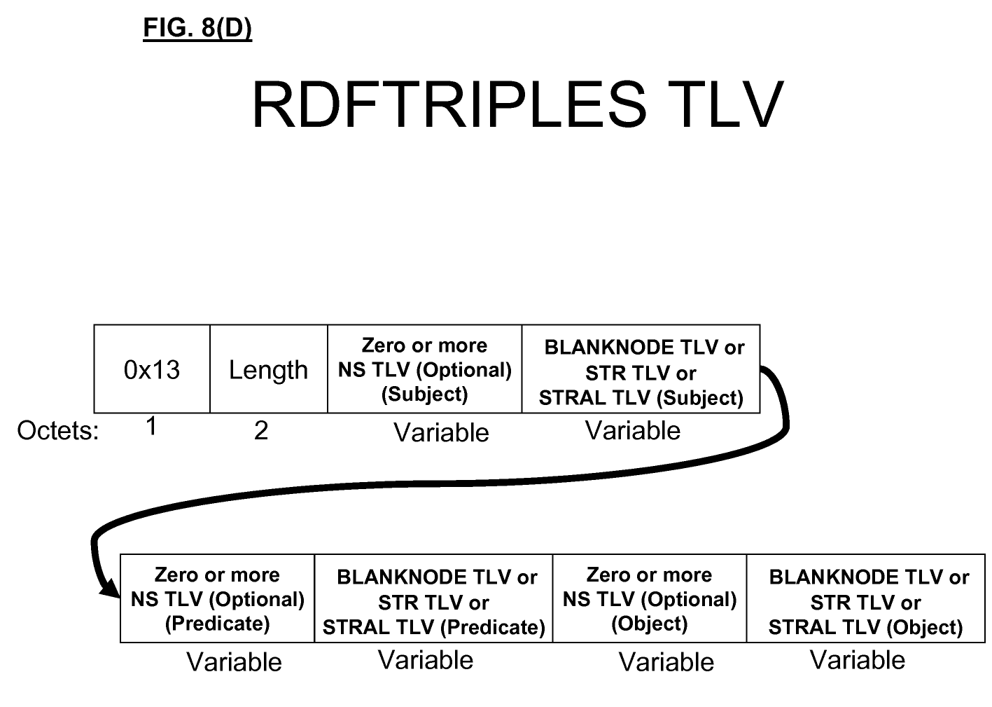

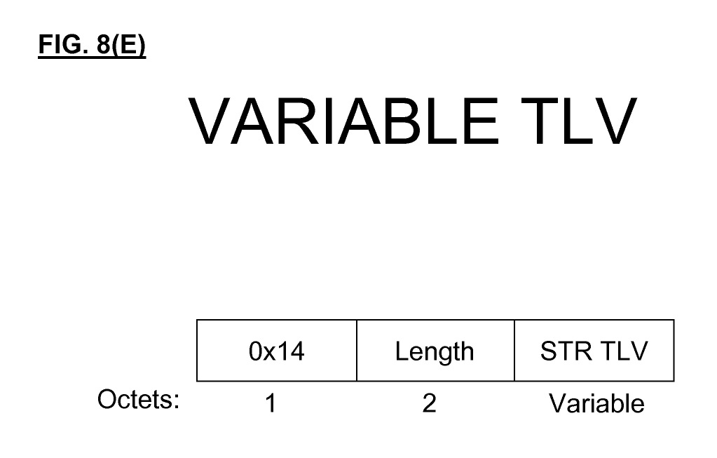

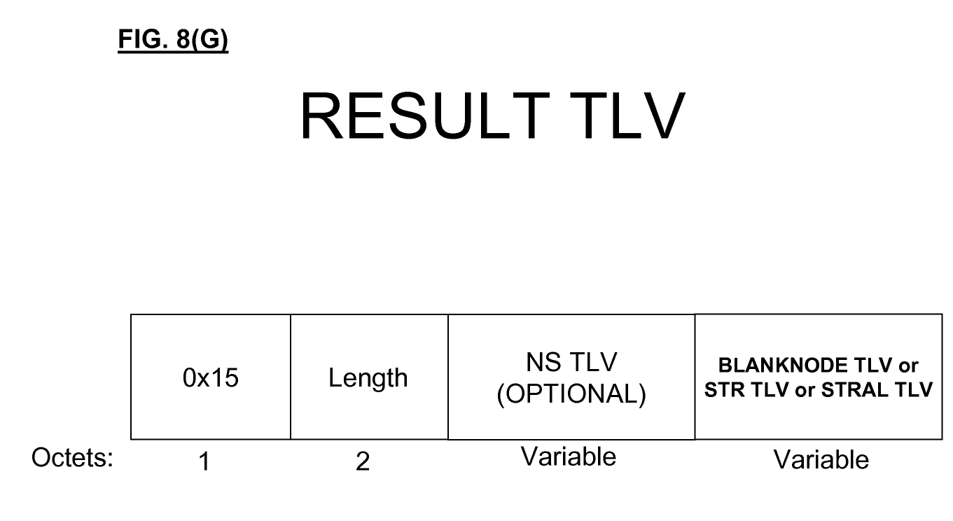

For reference, FIG. 7(A) shows an illustrative example of a Construction query. In this regard, the query can be, e.g., for obtaining IEs of a neighboring point of attachment (PoA). In addition, FIGS. 7(B)(i) and 7(B)(ii) show illustrative examples of Construction query results—i.e., with query results in XML 1.0 shown at the left side of the figure, and with query results in XML binary in TLV at the right side of the figure.

For reference, FIG. 7(C) shows an illustrative example of a Selection query. In this regard, the query can be, e.g., for obtaining a neighboring point of attachment (PoA). In addition, FIG. 7(D) shows an illustrative example of a Selection query result—i.e., with query results in XML 1.0 shown at the left side of the figure, and with query results in XML binary in TLV at the right side of the figure.

For reference, FIG. 7(E) shows an illustrative example of a Boolean query. In this regard, the query can be, e.g., for asking if a neighboring PoA is, e.g., 802.11. In addition, FIG. 7(F) shows an illustrative example of a Boolean query result—i.e., with query results in XML 1.0 shown at the left side of the figure, and with query results in XML binary in TLV at the right side of the figure.

With reference to Method B, other approaches can be optimized for SPARQL, not for XML. In this regard, with respect to the characteristics of the result of the SPARQL:
For a Construction query (e.g., used for sub-graph fetch), the result is, e.g., a sequence of RDF triples (e.g., Subject, Predicate, Object).
For a Selection query, the result is, e.g., a table of variables and values.
For a Boolean query, the result is, e.g., “yes” or “no.”

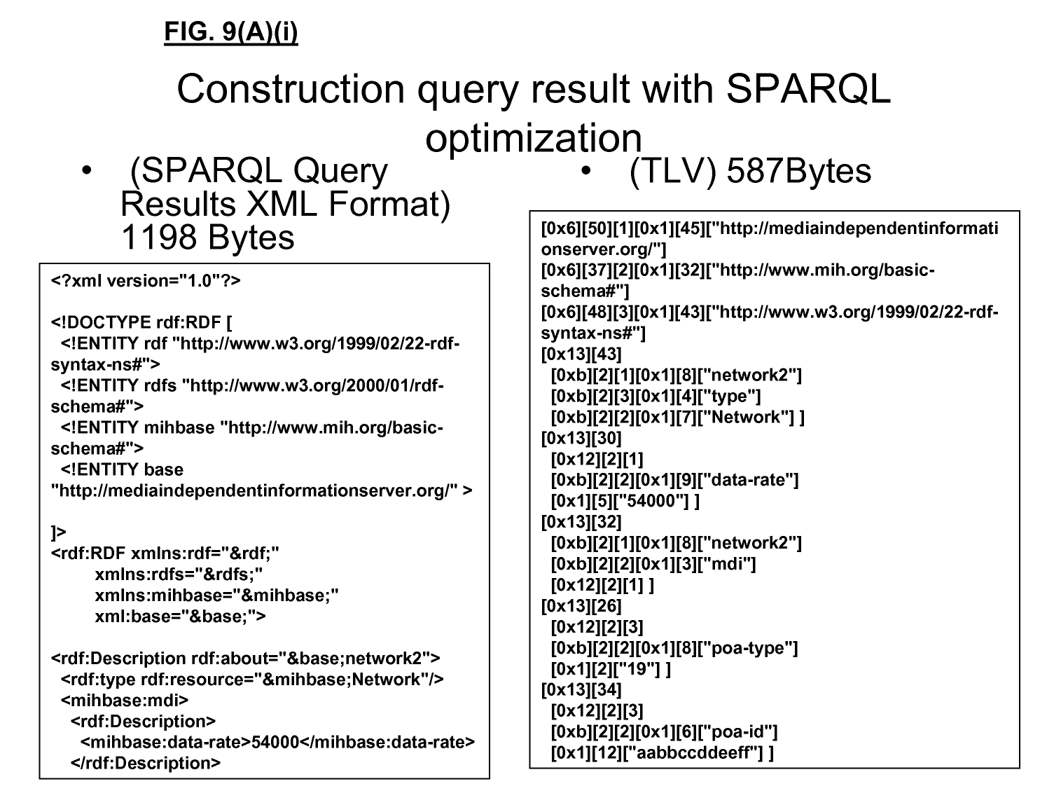

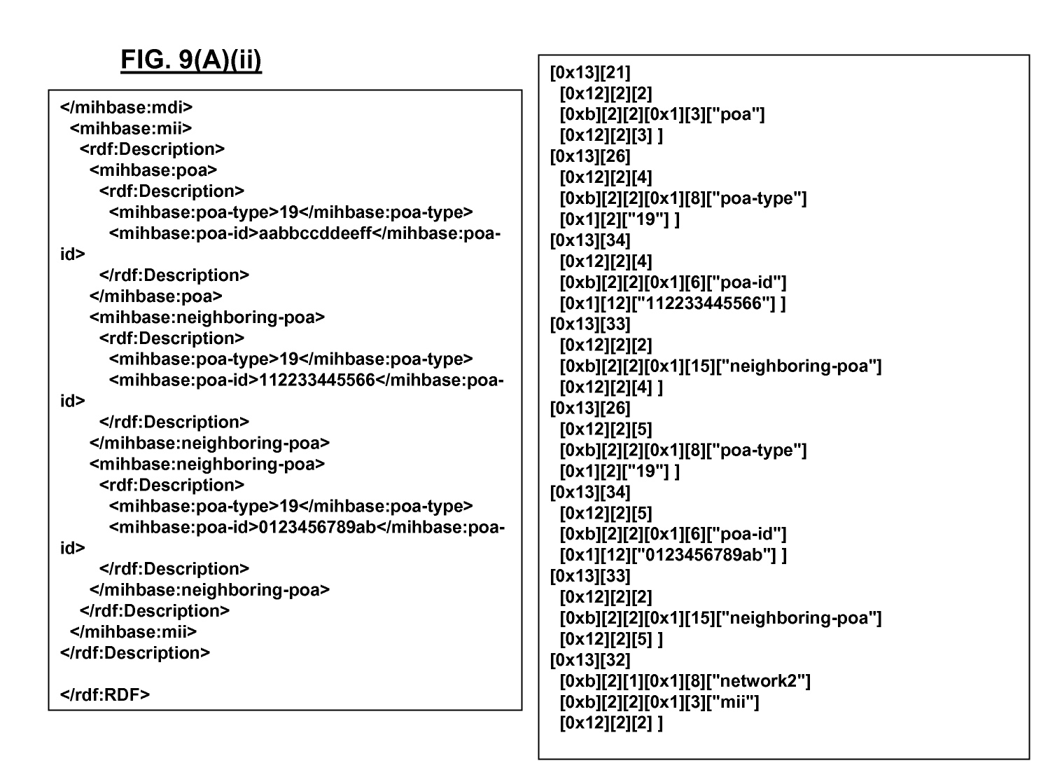

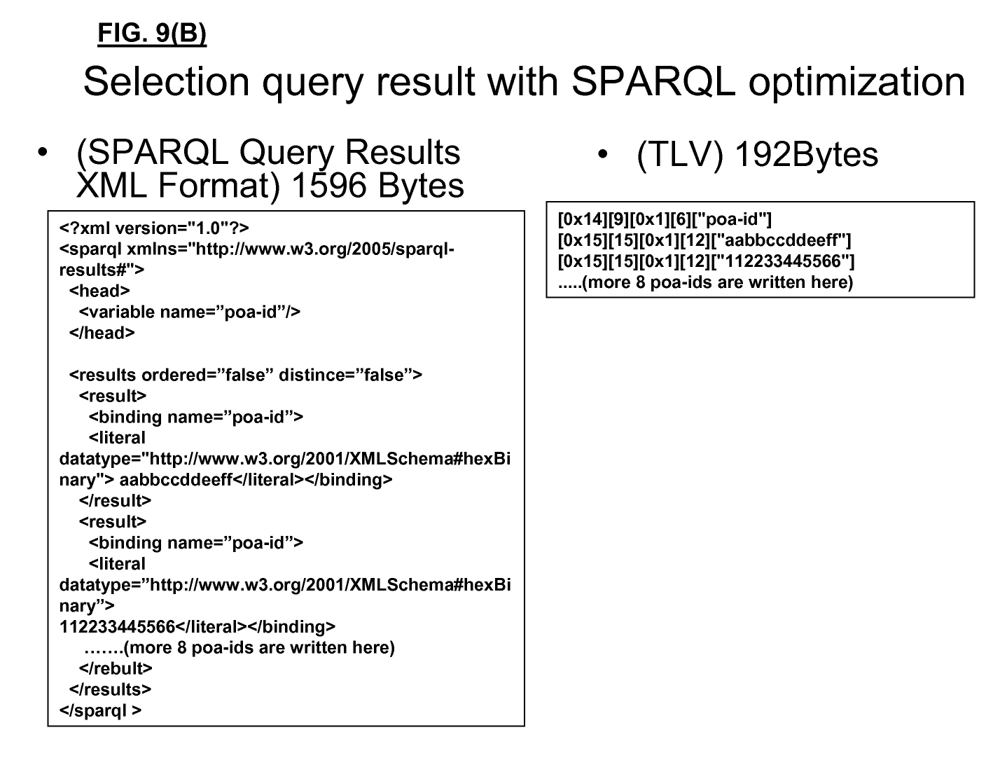

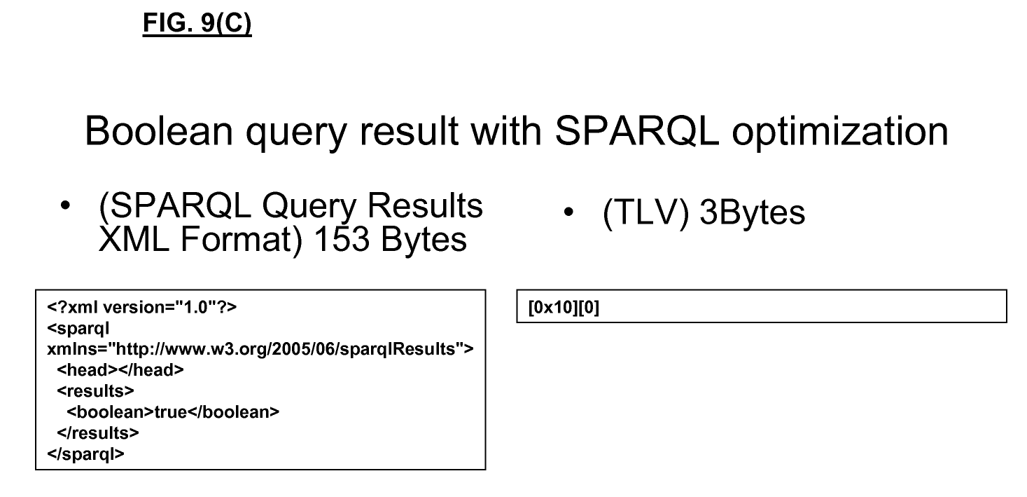

Some aspects related to implementation of Method B, according to some illustrative and non-limiting embodiments, are shown in FIGS. 9(A) to 9(G).

With reference to FIG. 9(A), in some illustrative examples the following YES TLV aspects may be employed:
Value field: NULL.
This TLV may be used for encoding, e.g., result of “yes” for Boolean query of SPARQL.
Preferably, when this TLV is carried, other TLVs carried in the same query result can be omitted.
Preferably, a receiver network device which receives this TLV decodes it to an appropriate XML format for the corresponding SPARQL Query results.

With reference to FIG. 9(B), in some illustrative examples the following NO TLV aspects may be employed:
Value field: NULL.
This TLV may be used for, e.g., encoding a result of “no” for a Boolean query of SPARQL.
Preferably, when this TLV is carried, other TLVs carried in the same query result can be omitted.
Preferably, a receiver network device which receives this TLV decodes it to an appropriate XML format for the corresponding SPARQL Query results.

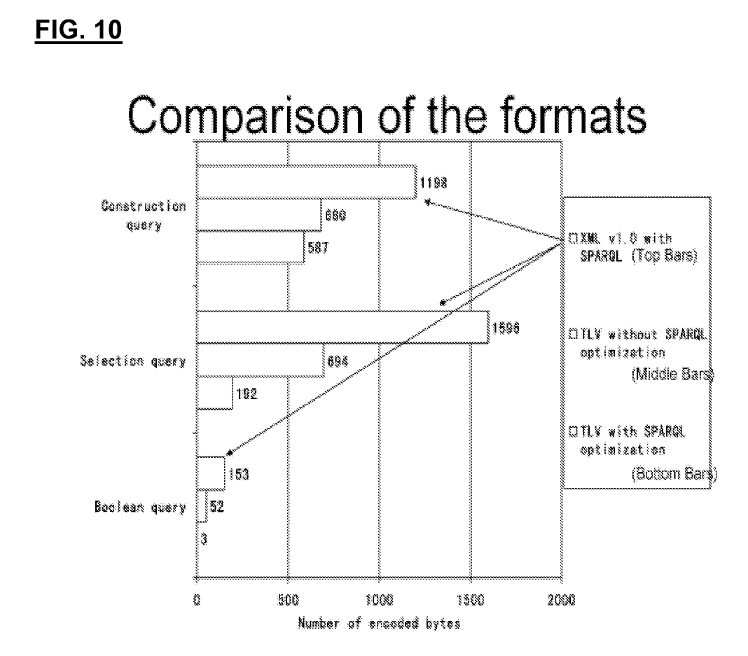

FIGS. 10(A)(i) to 10(A)(ii) show an illustrative Construction query result with SPARQL optimization according to some embodiments.

Furthermore, FIG. 10(B) shows an illustrative Selection query result with SPARQL optimization according to some embodiments.

In addition, FIG. 10(C) shows an illustrative Boolean query result with SPARQL optimization according to some embodiments.

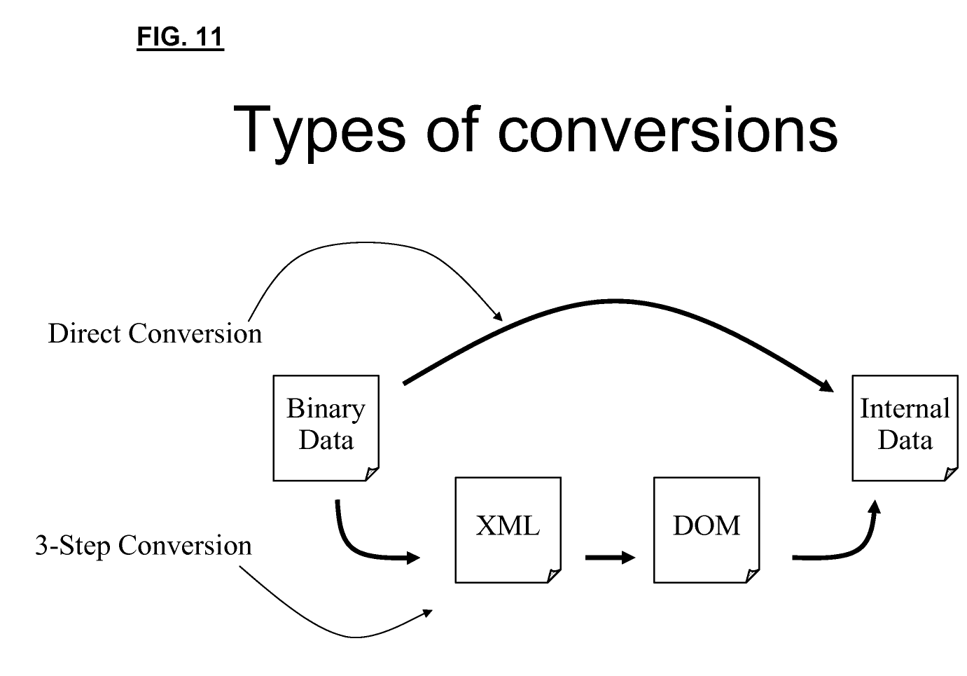

In addition, FIG. 11 shows a chart depicting some comparisons of the formats according to some illustrative and non-limiting examples.

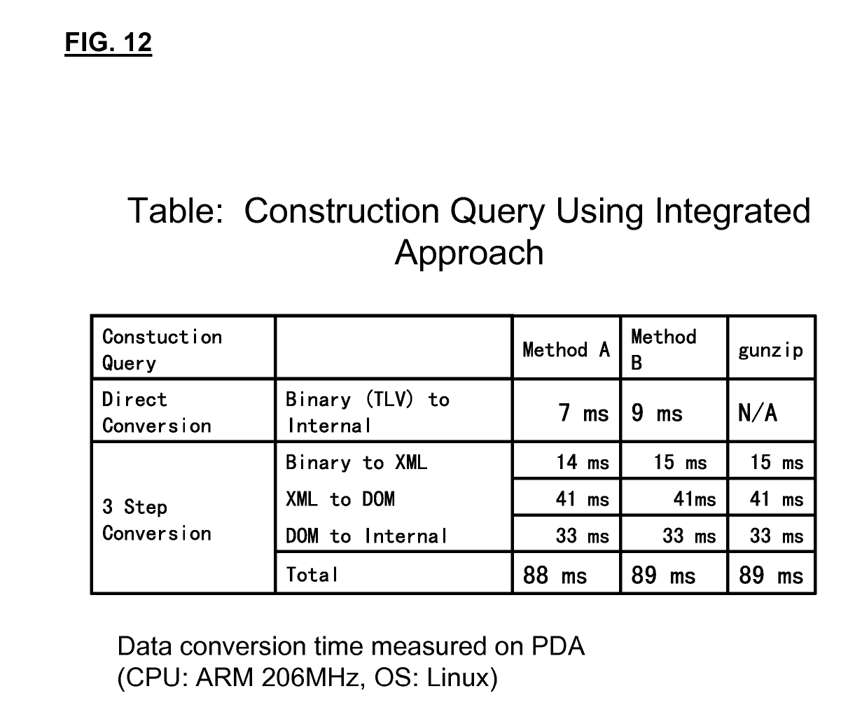

In addition, FIG. 12 is a diagram illustrating some types of conversions, including direct conversions and 3-step conversions from binary data to internal data.

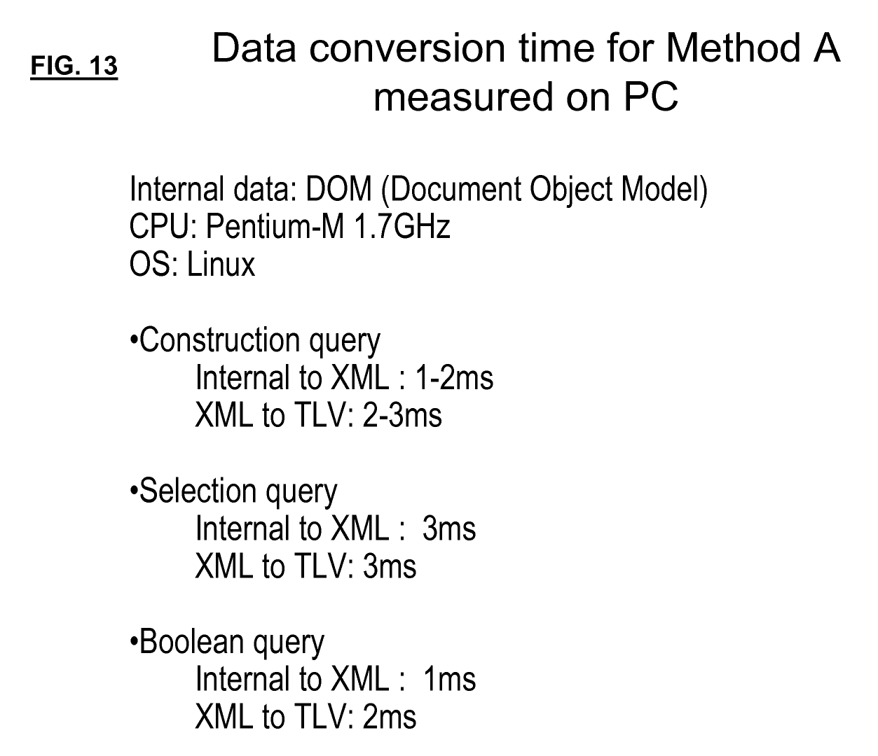

Moreover, FIG. 13 is a table showing some illustrative examples of data conversion times related to a construction query using an integrated approach under direct conversion and 3-step conversion examples, for Methods A, B and gunzip methods. In this regard, the table shows some sample results demonstrating how the query time can be reduced by using a combination of XML and TLV or by using a compressed version of XML (gunzip). Similarly, Selection query time and Boolean query time also get reduced by using a combination of XML and TLV. On average, Selection Query results in a delay similar to Construction Query, while time for Boolean Query is much smaller than the other two queries because of the number of bytes. In this regard, in some embodiments, Boolean Query byte size is about one-tenth of Selection Query byte size and about one-eighth of Construction Query byte-size.

Broad Scope of the Invention:

While illustrative embodiments of the invention have been described herein, the present invention is not limited to the various preferred embodiments described herein, but includes any and all embodiments having equivalent elements, modifications, omissions, combinations (e.g., of aspects across various embodiments), adaptations and/or alterations as would be appreciated by those in the art based on the present disclosure. The limitations in the claims (e.g., including that to be later added) are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to.” In this disclosure and during the prosecution of this application, means-plus-function or step-plus-function limitations will only be employed where for a specific claim limitation all of the following conditions are present in that limitation: a) “means for” or “step for” is expressly recited; b) a corresponding function is expressly recited; and c) structure, material or acts that support that structure are not recited. In this disclosure and during the prosecution of this application, the terminology “present invention” or “invention” may be used as a reference to one or more aspect within the present disclosure. The language present invention or invention should not be improperly interpreted as an identification of criticality, should not be improperly interpreted as applying across all aspects or embodiments (i.e., it should be understood that the present invention has a number of aspects and embodiments), and should not be improperly interpreted as limiting the scope of the application or claims. In this disclosure and during the prosecution of this application, the terminology “embodiment” can be used to describe any aspect, feature, process or step, any combination thereof, and/or any portion thereof, etc. In some examples, various embodiments may include overlapping features. In this disclosure, the following abbreviated terminology may be employed: “e.g.” which means “for example;” and “NB” which means “note well.”

What is claimed is:

1. A method for network discovery for a mobile device, comprising performing network discovery queries and/or responses between a mobile device and a point of attachment using a schema-based semantic query with binary encoding.

2. The method of claim 1, further including using XML for providing a schema-based semantic query, and TLV for providing a binary encoding.

3. The method of claim 2, further including converting XML data to TLV format.

4. The method of claim 1, including employing TLV with SPARQL optimization.

5. The method of claim 1, further including employing an XML binary representation.

6. The method of claim 5, further including converting XML data using an alias-based methodology.

7. The method of claim 6, further including a) converting XML namespace names to integers, b) converting XML tag names to integers, c) converting XML attribute names to integers, and/or d) converting ENTRY names to integers.

8. The method of claim 7, further including employing integer mapping.

9. The method of claim 8, wherein said integer mapping includes static mapping.

10. The method of claim 8, wherein said integer mapping includes dynamic mapping.

11. The method of claim 10, wherein said dynamic mapping is carried with data transmitted.

12. The method of claim 8, further including employing static mapping for pre-defined tags and/or attributes.

13. The method of claim 12, further including employing dynamic mapping for other tags, attributes and/or namespaces

14. The method of claim 1, further including converting XML data employing semantic bundling.

15. The method of claim 14, applicable to a particular query language, further including mapping two or more semantically-related XML tags to a single integer, and taking advantage of the knowledge of the particular query language syntax.

16. The method of claim 1, further including employing XML-based query language including construction query, selection query and/or boolean query.

17. The method of claim 16, further including employing a construction query for obtaining IEs of a neighboring point of attachment.

18. The method of claim 16, further including employing a selection query for obtaining a neighboring point of attachment.

19. The method of claim 16, further including employing a boolean query for inquiring if a neighboring point of attachment is of a particular network type.

20. The method of claim 16, further including employing a boolean query for inquiring if a neighboring point of attachment is an 802.11 point of attachment.

21. The method of claim 16, further including that for construction queries, RDF triples in XML are returned.

22. The method of claim 16, further including that for selection queries, selected bindings are returned.

23. The method of claim 16, further including that for boolean queries, yes or no values are returned.

24. A method for supporting query and response of a mobile device and a point of attachment in a network, comprising: using XML for a schema-based semantic query and TLV for binary encoding by converting XML data contained in a query result into TLV.
